(19) United States
(12) Patent Application Publication
(10) Pub. No.: US 2025/0247784 A1
(43) Pub. Date: Jul. 31, 2025

(54) SYSTEM INFORMATION OPERATION FOR NETWORK ENERGY SAVING

(71) Applicant: QUALCOMM Incorporated, San Diego, CA (US)

(72) Inventors: Navid ABEDINI, Basking Ridge, NJ (US); Jianghong LUO, Skillman, NJ (US); Sherif ELAZZOUNI, San Diego, CA (US); Naeem AKL, Bridgewater, NJ (US)

(21) Appl. No.: 18/424,013

(22) Filed: Jan. 26, 2024

(51) Int. Cl. H04W 52/02; H04W 48/14; H04W 48/16; H04W 68/00

(52) U.S. Cl. CPC H04W 52/0206; H04W 48/14; H04W 48/16; H04W 68/005

(57) ABSTRACT

Various aspects of the present disclosure generally relate to wireless communication. In some aspects, a user equipment (UE) may receive a communication including remaining minimum system information (RMSI) for a first cell that is operating in a network energy saving (NES) mode. The UE may perform an operation associated with a selection of the first cell, the selection of the first cell being in accordance with one or more conditions being met. Numerous other aspects are described.

### FIELD OF THE DISCLOSURE

Aspects of the present disclosure generally relate to wireless communication and specifically relate to techniques, apparatuses, and methods associated with a system information operation for network energy saving.

### BACKGROUND

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

The above multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, high-precision positioning, and/or radio frequency (RF) sensing, among other examples. As the demand for mobile broadband access continues to increase, further improvements in NR may be implemented, and other radio access technologies such as 6G may be introduced, to further advance mobile broadband evolution.

### SUMMARY

Some aspects described herein relate to a user equipment (UE) for wireless communication. The UE may include one or more memories and one or more processors coupled to the one or more memories. The one or more processors may be configured to cause the UE receive a communication including remaining minimum system information (RMSI) for a first cell that is operating in a network energy saving (NES) mode. The one or more processors may be configured to cause the UE to perform an operation associated with a selection of the first cell, the selection of the first cell being in accordance with one or more conditions being met.

Some aspects described herein relate to a network node for wireless communication. The network node may include one or more memories and one or more processors coupled to the one or more memories. The one or more processors may be configured to cause the network node to receive, for a UE, a request for system information for a first cell that is operating in an NES mode. The one or more processors may be configured to cause the network node to transmit a communication including RMSI for the first cell in accordance with one or more conditions being met.

Some aspects described herein relate to a method of wireless communication performed by a UE. The method may include receiving a communication including RMSI for a first cell that is operating in an NES mode. The method may include performing an operation associated with a selection of the first cell, the selection of the first cell being in accordance with one or more conditions being met.

Some aspects described herein relate to a method of wireless communication performed by a network node. The method may include receiving, for a UE, a request for system information for a first cell that is operating in an NES mode. The method may include transmitting a communication including RMSI for the first cell in accordance with one or more conditions being met.

Some aspects described herein relate to a non-transitory computer-readable medium that stores a set of instructions for wireless communication by a UE. The set of instructions, when executed by one or more processors of the UE, may cause the UE to receive a communication including RMSI for a first cell that is operating in an NES mode. The set of instructions, when executed by one or more processors of the UE, may cause the UE to perform an operation associated with a selection of the first cell, the selection of the first cell being in accordance with one or more conditions being met.

Some aspects described herein relate to a non-transitory computer-readable medium that stores a set of instructions for wireless communication by a network node. The set of instructions, when executed by one or more processors of the network node, may cause the network node to receive, for a UE, a request for system information for a first cell that is operating in an NES mode. The set of instructions, when executed by one or more processors of the network node, may cause the network node to transmit a communication including RMSI for the first cell in accordance with one or more conditions being met.

Some aspects described herein relate to an apparatus for wireless communication. The apparatus may include means for receiving a communication including RMSI for a first cell that is operating in an NES mode. The apparatus may include means for performing an operation associated with a selection of the first cell, the selection of the first cell being in accordance with one or more conditions being met.

Some aspects described herein relate to an apparatus for wireless communication. The apparatus may include means for receiving, for a UE, a request for system information for a first cell that is operating in an NES mode. The apparatus may include means for transmitting a communication including RMSI for the first cell in accordance with one or more conditions being met.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure, but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network in accordance with the present disclosure.

FIG. 2 is a diagram illustrating an example network node in communication with an example user equipment (UE) in a wireless network in accordance with the present disclosure.

FIG. 3 is a diagram illustrating an example disaggregated base station architecture in accordance with the present disclosure.

FIG. 4 is a diagram illustrating an example of a network energy saving operation in accordance with the present disclosure.

FIG. 5 is a diagram of an example associated with a system information operation for network energy saving in accordance with the present disclosure.

FIG. 6 is a diagram of an example associated with a system information operation for network energy saving in accordance with the present disclosure.

FIG. 7 is a diagram of an example associated with a system information operation for network energy saving in accordance with the present disclosure.

FIG. 8 is a diagram illustrating an example process performed, for example, at a UE or an apparatus of a UE, in accordance with the present disclosure.

FIG. 9 is a diagram illustrating an example process performed, for example, at a network node or an apparatus of a network node, in accordance with the present disclosure.

FIG. 10 is a diagram of an example apparatus for wireless communication, in accordance with the present disclosure.

FIG. 11 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms and is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Network energy saving (NES) and/or network energy efficiency measures are expected to have increased importance in wireless network operations for various reasons, such as climate change mitigation, environmental sustainability, and/or network cost reduction, among other examples. For example, although New Radio (NR) generally offers a significant energy efficiency improvement per gigabyte over previous generations (for example, long term evolution (LTE)), some NR use cases and/or the adoption of millimeter wave frequencies may require more network sites, more network antennas, larger bandwidths, and/or more frequency bands, among other examples, which may lead to more efficient wireless networks that nonetheless have higher energy requirements and/or cause more emissions than previous wireless network generations. Furthermore, energy accounts for a significant proportion of the cost to operate a wireless network. For example, according to some estimates, energy costs are about one-fourth the total cost to operate a wireless network, and over 90% of network operating costs are spent on energy (for example, fuel and electricity). The largest proportion of energy consumption and/or energy costs are associated with a radio access network (RAN), which accounts for about half of the energy consumption in a wireless network, with data centers and fiber transport accounting for smaller shares. Accordingly, measures to increase network energy savings and/or improve network energy efficiency are factors that may drive adoption and/or expansion of wireless networks.

One technique to increase energy efficiency in a RAN is to enable “on-demand” broadcast transmissions by a network node and/or a cell. For example, to reduce power consumption at a network node, the network node may transmit certain broadcast communications (e.g., system information communications, synchronization signal blocks (SSBs), and/or system information blocks (SIBs)) in an on-demand manner (e.g., rather than on a periodic basis or following a periodic schedule). In some examples, the on-demand communication may be a communication that carries remaining minimum system information (RMSI), such as a SIB type 1 (SIB1) or another SIB (e.g., as defined, or otherwise fixed, by a wireless communication standard, such as the 3GPP). In some examples, one or more SSBs and/or SIB1 may be transmitted via a cell to support initial access by UEs and measurement by user equipments (UEs), among other examples. Typically, such communications are periodically transmitted via the cell (e.g., following some periodic schedule where the communication(s) are transmitted one or more times each period) so that UEs moving into a geographic region of a cell can receive the communications and establish a communication connection via the cell. Therefore, one way to reduce network power consumption is to reduce a quantity of transmissions of such communications so that, for example, SSBs and SIB1s are transmitted less frequently by a cell operating in an NES mode (or NES state). As an example, SSBs and/or SIBs (e.g., SIB1) may be transmitted in an on-demand manner by a cell to conserve network power.

Although a UE may obtain system information and/or measurement information from a cell via one or more on-demand communications, the UE may be enabled to establish a connection with the cell, to camp on the cell, and/or to request system information for the cell without limitations. As a result, an efficiency or effectiveness of the NES mode of the cell may be reduced. For example, the UE may be enabled to establish a connection with the cell without limitations, which may result in the cell using additional power or energy to maintain or perform operations for the connection with the UE. As another example, the UE may be enabled to select the cell (e.g., camp on the cell). However, the cell may not transmit certain communications frequently enough to support camping by the UE, resulting in reduced performance for the UE. As another example, the UE may be enabled to transmit a request for system information from the cell at any time and/or without limitations, which may result in the cell having to frequently transmit on-demand communications (e.g., in response to requests from one or more UEs). The frequent on-demand communications may consume power and/or energy resources of the cell, thereby reducing an efficiency or effectiveness of the NES mode.

Various aspects relate generally to a system information operation for network energy saving. Some aspects more specifically relate to defining conditions or criteria for selection (e.g., for camping or for establishing a connection) of an NES cell by a UE. In some aspects, the conditions or criteria may be for UEs operating in an idle or inactive mode. In some aspects, the one or more conditions may be associated with a UE selecting an NES cell for establishing a communication connection (e.g., after receiving system information for the NES cell via the NES cell or another cell). As another example, the one or more conditions may be associated with a UE selecting an NES cell for camping. As another example, the one or more conditions may be associated with the UE transmitting a request for the system information of the NES cell (e.g., to the NES cell or to another cell).

In some aspects, the one or more conditions may include the UE being authorized by the network, the UE being paged, and/or the UE having an allowable subscription type, among other examples. In some aspects, an NES cell may support camping by UEs by transmitting one or more infrequent system information communications (e.g., while operating in the NES mode). In some aspects, the UE may receive configuration information for the one or more infrequent system information communications transmitted by the NES cell.

Particular aspects of the subject matter described in this disclosure can be implemented to realize one or more of the following potential advantages. In some examples, by restricting one or more operations (e.g., establishing a connection, camping, or another operation) associated with a selection of an NES cell, the described techniques can be used to improve an effectiveness or efficiency of the NES mode, thereby improving power savings of a cell operating in the NES mode. For example, by the UE establishing a connection with the NES cell only if the one or more conditions are satisfied or met, the described techniques can be used to reduce a likelihood that the UE establishes a connection with the NES cell for low priority communications or causes. As another example, by the UE transmitting a request for system information (e.g., SIB1) of the NES cell only if the one or more conditions are satisfied or met, the described techniques can be used to reduce the quantity of on-demand SIB1 transmissions by the NES cell. As another example, by configuring and/or supporting the infrequent system information transmissions, a UE may be enabled to camp on an NES cell in certain scenarios (e.g., if the one or more conditions are met or satisfied), improving access to the NES cell and/or improving network access for the UE.

Multiple-access radio access technologies (RATs) have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the Third Generation Partnership Project (3GPP). 5G NR supports various technologies and use cases including enhanced mobile broadband (eMBB), ultra-reliable low-latency communication (URLLC), massive machine-type communication (mMTC), millimeter wave (mmWave) technology, beamforming, network slicing, edge computing, Internet of Things (IoT) connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) UE functionality, industrial connectivity, multiple-subscriber implementations, high-precision positioning, radio frequency (RF) sensing, and/or artificial intelligence or machine learning (AI/ML), among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

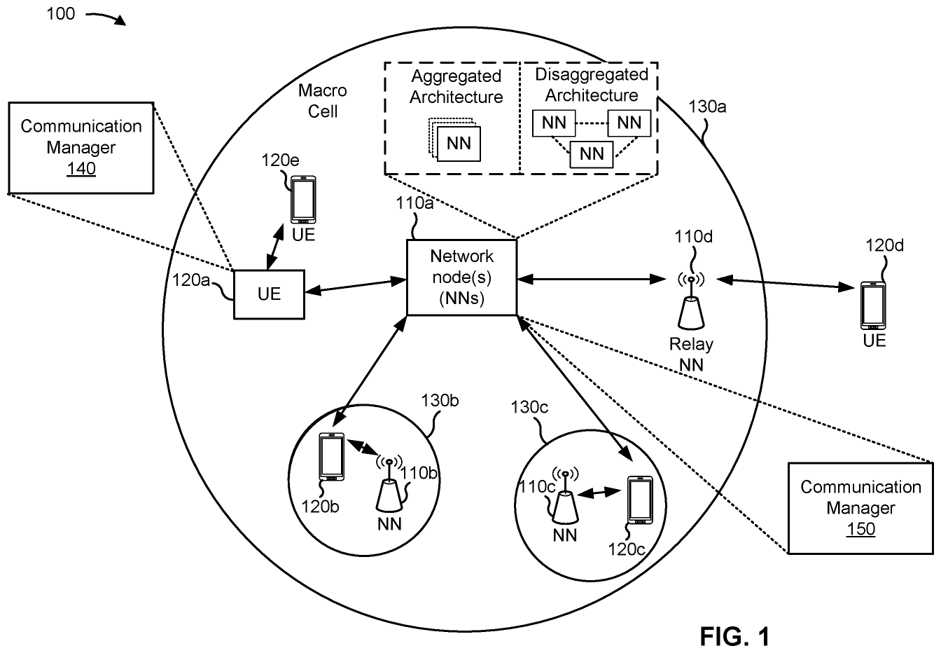

FIG. 1 is a diagram illustrating an example of a wireless communication network 100 in accordance with the present disclosure. The wireless communication network 100 may be or may include elements of a 5G (or NR) network or a 6G network, among other examples. The wireless communication network 100 may include multiple network nodes 110, shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120e.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless networks 100 may be deployed in a given geographic area. Each wireless communication network 100 may support a particular RAT (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHZ), FR2 (24.25 GHz through 52.6 GHz), FR3 (7.125 GHz through 24.25 GHZ), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “Sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHz,” if used herein, may broadly refer to frequencies that are less than 6 GHZ, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 may implement dynamic spectrum sharing (DSS), in which multiple RATs (for example, 4G/LTE and 5G/NR) are implemented with dynamic bandwidth allocation (for example, based on user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a radio access network (RAN).

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node (having an aggregated architecture), meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network of the wireless communication network 100.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. For example, a disaggregated network node may have a disaggregated architecture. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more central units (CUs), one or more distributed units (DUs), and/or one or more radio units (RUs). A CU may host one or more higher layer control functions, such as radio resource control (RRC) functions, packet data convergence protocol (PDCP) functions, and/or service data adaptation protocol (SDAP) functions, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (iFFT), beamforming, physical random access channel (PRACH) extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 120.

In some aspects, a single network node 110 may include a combination of one or more CUs, one or more DUs, and/or one or more RUs. Additionally or alternatively, a network node 110 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In some examples, a cell may not necessarily be stationary. For example, the geographic area of the cell may move according to the location of an associated mobile network node 110 (for example, a train, a satellite base station, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c. Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink channels may include one or more control channels and one or more data channels. A downlink control channel may be used to transmit downlink control information (DCI) (for example, scheduling information, reference signals, and/or configuration information) from a network node 110 to a UE 120. A downlink data channel may be used to transmit downlink data (for example, user data associated with a UE 120) from a network node 110 to a UE 120. Downlink control channels may include one or more physical downlink control channels (PDCCHs), and downlink data channels may include one or more physical downlink shared channels (PDSCHs). Uplink channels may similarly include one or more control channels and one or more data channels. An uplink control channel may be used to transmit uplink control information (UCI) (for example, reference signals and/or feedback corresponding to one or more downlink transmissions) from a UE 120 to a network node 110. An uplink data channel may be used to transmit uplink data (for example, user data associated with a UE 120) from a UE 120 to a network node 110. Uplink control channels may include one or more physical uplink control channels (PUCCHs), and uplink data channels may include one or more physical uplink shared channels (PUSCHs). The downlink and the uplink may each include a set of resources on which the network node 110 and the UE 120 may communicate.

Downlink and uplink resources may include time domain resources (frames, subframes, slots, and/or symbols), frequency domain resources (frequency bands, component carriers, subcarriers, resource blocks, and/or resource elements), and/or spatial domain resources (particular transmit directions and/or beam parameters). Frequency domain resources of some bands may be subdivided into bandwidth parts (BWPs). A BWP may be a continuous block of frequency domain resources (for example, a continuous block of resource blocks) that are allocated for one or more UEs 120. A UE 120 may be configured with both an uplink BWP and a downlink BWP (where the uplink BWP and the downlink BWP may be the same BWP or different BWPs). A BWP may be dynamically configured (for example, by a network node 110 transmitting a DCI configuration to the one or more UEs 120) and/or reconfigured, which means that a BWP can be adjusted in real-time (or near-real-time) based on changing network conditions in the wireless communication network 100 and/or based on the specific requirements of the one or more UEs 120. This enables more efficient use of the available frequency domain resources in the wireless communication network 100 because fewer frequency domain resources may be allocated to a BWP for a UE 120 (which may reduce the quantity of frequency domain resources that a UE 120 is required to monitor), leaving more frequency domain resources to be spread across multiple UEs 120. Thus, BWPs may also assist in the implementation of lower-capability UEs 120 by facilitating the configuration of smaller bandwidths for communication by such UEs 120.

As described above, in some aspects, the wireless communication network 100 may be, may include, or may be included in, an IAB network. In an IAB network, at least one network node 110 is an anchor network node that communicates with a core network. An anchor network node 110 may also be referred to as an IAB donor (or “IAB-donor”). The anchor network node 110 may connect to the core network via a wired backhaul link. For example, an Ng interface of the anchor network node 110 may terminate at the core network. Additionally or alternatively, an anchor network node 110 may connect to one or more devices of the core network that provide a core access and mobility management function (AMF). An IAB network also generally includes multiple non-anchor network nodes 110, which may also be referred to as relay network nodes or simply as IAB nodes (or “IAB-nodes”). Each non-anchor network node 110 may communicate directly with the anchor network node 110 via a wireless backhaul link to access the core network, or may communicate indirectly with the anchor network node 110 via one or more other non-anchor network nodes 110 and associated wireless backhaul links that form a backhaul path to the core network. Some anchor network node 110 or other non-anchor network node 110 may also communicate directly with one or more UEs 120 via wireless access links that carry access traffic. In some examples, network resources for wireless communication (such as time resources, frequency resources, and/or spatial resources) may be shared between access links and backhaul links.

In some examples, any network node 110 that relays communications may be referred to as a relay network node, a relay station, or simply as a relay. A relay may receive a transmission of a communication from an upstream station (for example, another network node 110 or a UE 120) and transmit the communication to a downstream station (for example, a UE 120 or another network node 110). In this case, the wireless communication network 100 may include or be referred to as a “multi-hop network.” In the example shown in FIG. 1, the network node 110d (for example, a relay network node) may communicate with the network node 110a (for example, a macro network node) and the UE 120d in order to facilitate communication between the network node 110a and the UE 120d. Additionally or alternatively, a UE 120 may be or may operate as a relay station that can relay transmissions to or from other UEs 120. A UE 120 that relays communications may be referred to as a UE relay or a relay UE, among other examples.

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

Some UEs 120 may be considered machine-type communication (MTC) UEs, evolved or enhanced machine-type communication (eMTC), UEs, further enhanced eMTC (feMTC) UEs, or enhanced feMTC (efeMTC) UEs, or further evolutions thereof, all of which may be simply referred to as “MTC UEs”). An MTC UE may be, may include, or may be included in or coupled with a robot, an uncrewed aerial vehicle, a remote device, a sensor, a meter, a monitor, and/or a location tag. Some UEs 120 may be considered IoT devices and/or may be implemented as NB-IoT (narrowband IoT) devices. An IoT UE or NB-IoT device may be, may include, or may be included in or coupled with an industrial machine, an appliance, a refrigerator, a doorbell camera device, a home automation device, and/or a light fixture, among other examples. Some UEs 120 may be considered Customer Premises Equipment, which may include telecommunications devices that are installed at a customer location (such as a home or office) to enable access to a service provider's network (such as included in or in communication with the wireless communication network 100).

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, enhanced mobile broadband (eMBB), and/or precise positioning in the wireless communication network 100, among other examples. A third category of UEs 120 may have mid-tier complexity and/or capability (for example, a capability between UEs 120 of the first category and UEs 120 of the second capability). A UE 120 of the third category may be referred to as a reduced capacity UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, and/or cameras that are associated with a limited bandwidth, power capacity, and/or transmission range, among other examples. RedCap UEs may support healthcare environments, building automation, electrical distribution, process automation, transport and logistics, and/or smart city deployments, among other examples.

In some examples, two or more UEs 120 (for example, shown as UE 120a and UE 120e) may communicate directly with one another using sidelink communications (for example, without communicating by way of a network node 110 as an intermediary). As an example, the UE 120a may directly transmit data, control information, or other signaling as a sidelink communication to the UE 120e. This is in contrast to, for example, the UE 120a first transmitting data in an UL communication to a network node 110, which then transmits the data to the UE 120e in a DL communication. In various examples, the UEs 120 may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 110 may schedule and/or allocate resources for sidelink communications between UEs 120 in the wireless communication network 100. In some other deployments and configurations, a UE 120 (instead of a network node 110) may perform, or collaborate or negotiate with one or more other UEs to perform, scheduling operations, resource selection operations, and/or other operations for sidelink communications.

In various examples, some of the network nodes 110 and the UEs 120 of the wireless communication network 100 may be configured for full-duplex operation in addition to half-duplex operation. A network node 110 or a UE 120 operating in a half-duplex mode may perform only one of transmission or reception during particular time resources, such as during particular slots, symbols, or other time periods. Half-duplex operation may involve time-division duplexing (TDD), in which DL transmissions of the network node 110 and UL transmissions of the UE 120 do not occur in the same time resources (that is, the transmissions do not overlap in time). In contrast, a network node 110 or a UE 120 operating in a full-duplex mode can transmit and receive communications concurrently (for example, in the same time resources). By operating in a full-duplex mode, network nodes 110 and/or UEs 120 may generally increase the capacity of the network and the radio access link. In some examples, full-duplex operation may involve frequency-division duplexing (FDD), in which DL transmissions of the network node 110 are performed in a first frequency band or on a first component carrier and transmissions of the UE 120 are performed in a second frequency band or on a second component carrier different than the first frequency band or the first component carrier, respectively. In some examples, full-duplex operation may be enabled for a UE 120 but not for a network node 110. For example, a UE 120 may simultaneously transmit an UL transmission to a first network node 110 and receive a DL transmission from a second network node 110 in the same time resources. In some other examples, full-duplex operation may be enabled for a network node 110 but not for a UE 120. For example, a network node 110 may simultaneously transmit a DL transmission to a first UE 120 and receive an UL transmission from a second UE 120 in the same time resources. In some other examples, full-duplex operation may be enabled for both a network node 110 and a UE 120.

In some examples, the UEs 120 and the network nodes 110 may perform MIMO communication. “MIMO” generally refers to transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some examples, MIMO may support simultaneous transmission to multiple receivers, referred to as multi-user MIMO (MU-MIMO). Some RATs may employ advanced MIMO techniques, such as mTRP operation (including redundant transmission or reception on multiple TRPs), reciprocity in the time domain or the frequency domain, single-frequency-network (SFN) transmission, or non-coherent joint transmission (NC-JT).

In some aspects, the UE 120 may include a communication manager 140. As described in more detail elsewhere herein, the communication manager 140 may receive a communication including RMSI for a first cell that is operating in an NES mode; and perform an operation associated with a selection of the first cell, the selection of the first cell being in accordance with one or more conditions being met. Additionally, or alternatively, the communication manager 140 may perform one or more other operations described herein.

In some aspects, the network node 110 may include a communication manager 150. As described in more detail elsewhere herein, the communication manager 150 may receive, for a UE (e.g., a UE 120), a request for system information for a first cell that is operating in an NES mode; and transmit a communication including RMSI for the first cell in accordance with one or more conditions being met. Additionally, or alternatively, the communication manager 150 may perform one or more other operations described herein.

As indicated above, FIG. 1 is provided as an example. Other examples may differ from what is described with regard to FIG. 1.

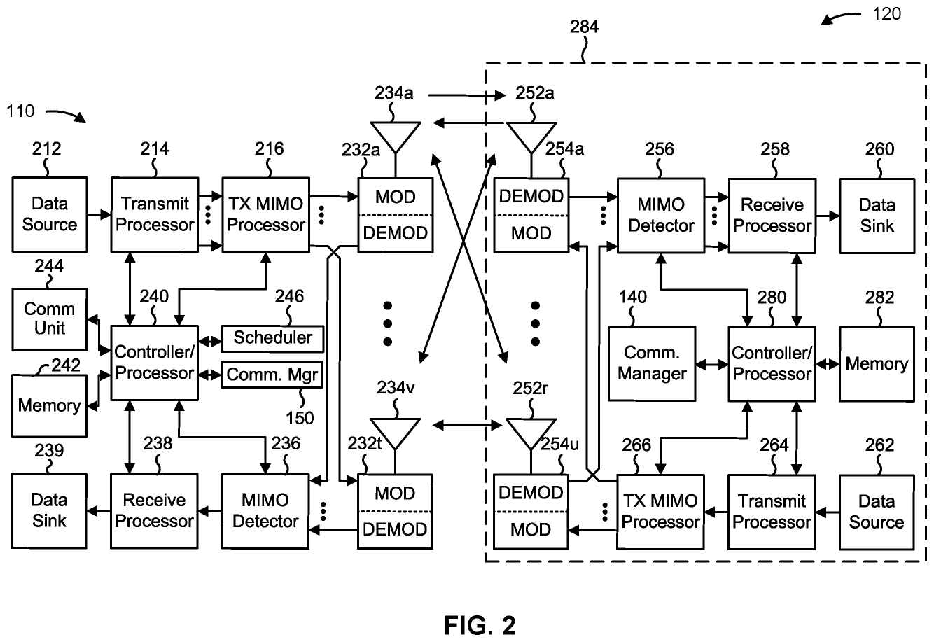

FIG. 2 is a diagram illustrating an example network node 110 in communication with an example UE 120 in a wireless network in accordance with the present disclosure.

As shown in FIG. 2, the network node 110 may include a data source 212, a transmit processor 214, a transmit (TX) MIMO processor 216, a set of modems 232 (shown as 232a through 232t, where t≥1), a set of antennas 234 (shown as 234a through 234v, where v≥1), a MIMO detector 236, a receive processor 238, a data sink 239, a controller/processor 240, a memory 242, a communication unit 244, a scheduler 246, and/or a communication manager 150, among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 110. The transceiver may be under control of and used by one or more processors, such as the controller/processor 240, and in some aspects in conjunction with processor-readable code stored in the memory 242, to perform aspects of the methods, processes, and/or operations described herein. In some aspects, the network node 110 may include one or more interfaces, communication components, and/or other components that facilitate communication with the UE 120 or another network node.

The terms “processor,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 110 may include transmit processor 214, TX MIMO processor 216, MIMO detector 236, receive processor 238, and/or controller/processor 240. Similarly, one or more processors of the UE 120 may include MIMO detector 256, receive processor 258, transmit processor 264, TX MIMO processor 266, and/or controller/processor 280.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

For downlink communication from the network node 110 to the UE 120, the transmit processor 214 may receive data (“downlink data”) intended for the UE 120 (or a set of UEs that includes the UE 120) from the data source 212 (such as a data pipeline or a data queue). In some examples, the transmit processor 214 may select one or more MCSs for the UE 120 in accordance with one or more channel quality indicators (CQIs) received from the UE 120. The network node 110 may process the data (for example, including encoding the data) for transmission to the UE 120 on a downlink in accordance with the MCS(s) selected for the UE 120 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a demodulation reference signal (DMRS), or a channel state information (CSI) reference signal (CSI-RS)) and/or synchronization signals (for example, a primary synchronization signal (PSS) or a secondary synchronization signals (SSS)).

The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing (OFDM)) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example, T downlink signals) via the corresponding set of antennas 234.

A downlink signal may include a DCI communication, a MAC control element (MAC-CE) communication, an RRC communication, a downlink reference signal, or another type of downlink communication. Downlink signals may be transmitted on a PDCCH, a PDSCH, and/or on another downlink channel. A downlink signal may carry one or more transport blocks (TBs) of data. A TB may be a unit of data that is transmitted over an air interface in the wireless communication network 100. A data stream (for example, from the data source 212) may be encoded into multiple TBs for transmission over the air interface. The quantity of TBs used to carry the data associated with a particular data stream may be associated with a TB size common to the multiple TBs. The TB size may be based on or otherwise associated with radio channel conditions of the air interface, the MCS used for encoding the data, the downlink resources allocated for transmitting the data, and/or another parameter. In general, the larger the TB size, the greater the amount of data that can be transmitted in a single transmission, which reduces signaling overhead. However, larger TB sizes may be more prone to transmission and/or reception errors than smaller TB sizes, but such errors may be mitigated by more robust error correction techniques.

For uplink communication from the UE 120 to the network node 110, uplink signals from the UE 120 may be received by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 110 may use the scheduler 246 to schedule one or more UEs 120 for downlink or uplink communications. In some aspects, the scheduler 246 may use DCI to dynamically schedule DL transmissions to the UE 120 and/or UL transmissions from the UE 120. In some examples, the scheduler 246 may allocate recurring time domain resources and/or frequency domain resources that the UE 120 may use to transmit and/or receive communications using an RRC configuration (for example, a semi-static configuration), for example, to perform semi-persistent scheduling (SPS) or to configure a configured grant (CG) for the UE 120.

One or more of the transmit processor 214, the TX MIMO processor 216, the modem 232, the antenna 234, the MIMO detector 236, the receive processor 238, and/or the controller/processor 240 may be included in an RF chain of the network node 110. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 110). In some aspects, the RF chain may be or may be included in a transceiver of the network node 110.

In some examples, the network node 110 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 110 may use the communication unit 244 to transmit and/or receive data associated with the UE 120 or to perform network control signaling, among other examples. The communication unit 244 may include a transceiver and/or an interface, such as a network interface.

The UE 120 may include a set of antennas 252 (shown as antennas 252a through 252r, where r≥1), a set of modems 254 (shown as modems 254a through 254u, where u≥1), a MIMO detector 256, a receive processor 258, a data sink 260, a data source 262, a transmit processor 264, a TX MIMO processor 266, a controller/processor 280, a memory 282, and/or a communication manager 140, among other examples. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be under control of and used by one or more processors, such as the controller/processor 280, and in some aspects in conjunction with processor-readable code stored in the memory 282, to perform aspects of the methods, processes, or operations described herein. In some aspects, the UE 120 may include another interface, another communication component, and/or another component that facilitates communication with the network node 110 and/or another UE 120.

For downlink communication from the network node 110 to the UE 120, the set of antennas 252 may receive the downlink communications or signals from the network node 110 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 120 to the data sink 260 (which may include a data pipeline, a data queue, and/or an application executed on the UE 120), and may provide decoded control information and system information to the controller/processor 280.

For uplink communication from the UE 120 to the network node 110, the transmit processor 264 may receive and process data (“uplink data”) from a data source 262 (such as a data pipeline, a data queue, and/or an application executed on the UE 120) and control information from the controller/processor 280. The control information may include one or more parameters, feedback, one or more signal measurements, and/or other types of control information. In some aspects, the receive processor 258 and/or the controller/processor 280 may determine, for a received signal (such as received from the network node 110 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a CQI parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 120 by the network node 110.

The transmit processor 264 may generate reference symbols for one or more reference signals, such as an uplink DMRS, an uplink sounding reference signal (SRS), and/or another type of reference signal. The symbols from the transmit processor 264 may be precoded by the TX MIMO processor 266, if applicable, and further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, U output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254u may transmit a set of uplink signals (for example, R uplink signals or U uplink symbols) via the corresponding set of antennas 252. An uplink signal may include a UCI communication, a MAC-CE communication, an RRC communication, or another type of uplink communication. Uplink signals may be transmitted on a PUSCH, a PUCCH, and/or another type of uplink channel. An uplink signal may carry one or more TBs of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range.

The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal. In some implementations, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 120 or network nodes 110 may include different numbers of antenna elements. For example, a UE 120 may include a single antenna element, two antenna elements, four antenna elements, eight antenna elements, or a different number of antenna elements. As another example, a network node 110 may include eight antenna elements, 24 antenna elements, 64 antenna elements, 128 antenna elements, or a different number of antenna elements. Generally, a larger number of antenna elements may provide increased control over parameters for beam generation relative to a smaller number of antenna elements, whereas a smaller number of antenna elements may be less complex to implement and may use less power than a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

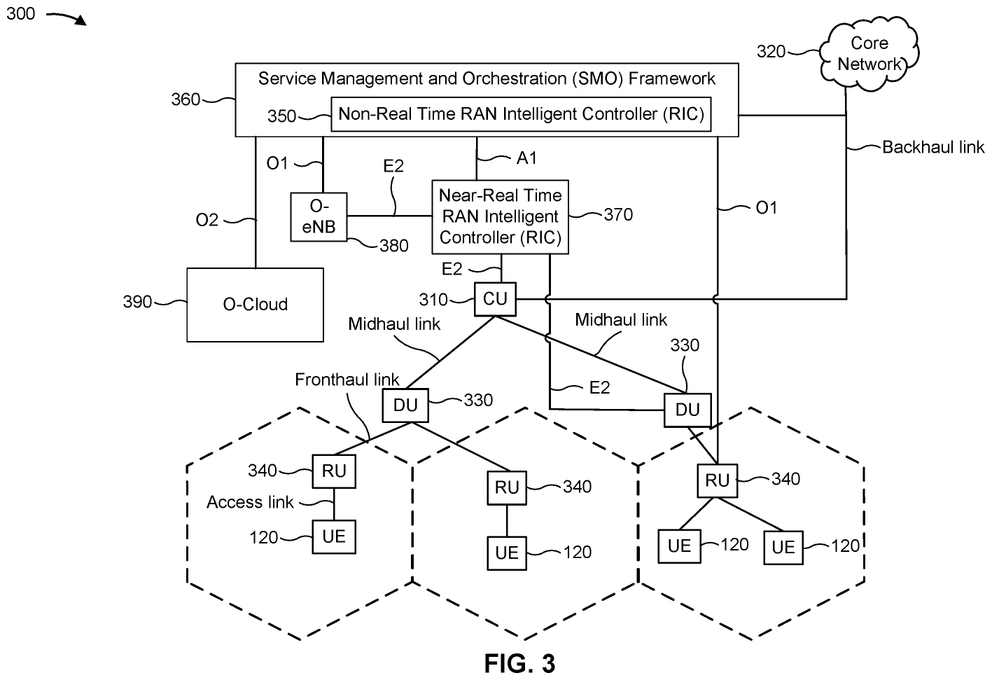

FIG. 3 is a diagram illustrating an example disaggregated base station architecture 300 in accordance with the present disclosure. One or more components of the example disaggregated base station architecture 300 may be, may include, or may be included in one or more network nodes (such one or more network nodes 110). The disaggregated base station architecture 300 may include a CU 310 that can communicate directly with a core network 320 via a backhaul link, or that can communicate indirectly with the core network 320 via one or more disaggregated control units, such as a Non-RT RIC 350 associated with a Service Management and Orchestration (SMO) Framework 360 and/or a Near-RT RIC 370 (for example, via an E2 link). The CU 310 may communicate with one or more DUs 330 via respective midhaul links, such as via F1 interfaces. Each of the DUs 330 may communicate with one or more RUs 340 via respective fronthaul links. Each of the RUs 340 may communicate with one or more UEs 120 via respective RF access links. In some deployments, a UE 120 may be simultaneously served by multiple RUs 340.

Each of the components of the disaggregated base station architecture 300, including the CUs 310, the DUs 330, the RUs 340, the Near-RT RICs 370, the Non-RT RICs 350, and the SMO Framework 360, may include one or more interfaces or may be coupled with one or more interfaces for receiving or transmitting signals, such as data or information, via a wired or wireless transmission medium.

In some aspects, the CU 310 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. For example, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some aspects, real-time and non-real-time aspects of control and user plane communication with the RU(s) 340 may be controlled by the corresponding DU 330.

The SMO Framework 360 may support RAN deployment and provisioning of non-virtualized and virtualized network elements. For non-virtualized network elements, the SMO Framework 360 may support the deployment of dedicated physical resources for RAN coverage requirements, which may be managed via an operations and maintenance interface, such as an O1 interface. For virtualized network elements, the SMO Framework 360 may interact with a cloud computing platform (such as an open cloud (O-Cloud) platform 390) to perform network element life cycle management (such as to instantiate virtualized network elements) via a cloud computing platform interface, such as an O2 interface. A virtualized network element may include, but is not limited to, a CU 310, a DU 330, an RU 340, a non-RT RIC 350, and/or a Near-RT RIC 370. In some aspects, the SMO Framework 360 may communicate with a hardware aspect of a 4G RAN, a 5G NR RAN, and/or a 6G RAN, such as an open eNB (O-eNB) 380, via an O1 interface. Additionally or alternatively, the SMO Framework 360 may communicate directly with each of one or more RUs 340 via a respective O1 interface. In some deployments, this configuration can enable each DU 330 and the CU 310 to be implemented in a cloud-based RAN architecture, such as a vRAN architecture.

The Non-RT RIC 350 may include or may implement a logical function that enables non-real-time control and optimization of RAN elements and resources, AI/ML workflows including model training and updates, and/or policy-based guidance of applications and/or features in the Near-RT RIC 370. The Non-RT RIC 350 may be coupled to or may communicate with (such as via an A1 interface) the Near-RT RIC 370. The Near-RT RIC 370 may include or may implement a logical function that enables near-real-time control and optimization of RAN elements and resources via data collection and actions via an interface (such as via an E2 interface) connecting one or more CUs 310, one or more DUs 330, and/or an O-eNB with the Near-RT RIC 370.

In some aspects, to generate AI/ML models to be deployed in the Near-RT RIC 370, the Non-RT RIC 350 may receive parameters or external enrichment information from external servers. Such information may be utilized by the Near-RT RIC 370 and may be received at the SMO Framework 360 or the Non-RT RIC 350 from non-network data sources or from network functions. In some examples, the Non-RT RIC 350 or the Near-RT RIC 370 may tune RAN behavior or performance. For example, the Non-RT RIC 350 may monitor long-term trends and patterns for performance and may employ AI/ML models to perform corrective actions via the SMO Framework 360 (such as reconfiguration via an O1 interface) or via creation of RAN management policies (such as A1 interface policies).

As indicated above, FIG. 3 is provided as an example. Other examples may differ from what is described with regard to FIG. 3.

As used herein, a network node 110 “outputting” or “transmitting” a communication to a UE 120 may refer to a direct transmission (for example, from the network node 110 to the UE 120) or an indirect transmission via one or more other network nodes or devices. For example, if the network node 110 is a DU, an indirect transmission to the UE 120 may include the DU outputting or transmitting a communication to an RU and the RU transmitting the communication to the UE 120, or may include causing the RU to transmit the communication (e.g., triggering transmission of a physical layer reference signal). Similarly, the UE 120 “transmitting” a communication to the network node 110 may refer to a direct transmission (for example, from the UE 120 to the network node 110) or an indirect transmission via one or more other network nodes or devices. For example, if the network node 110 is a DU, an indirect transmission to the network node 110 may include the UE 120 transmitting a communication to an RU and the RU transmitting the communication to the DU. Similarly, the network node 110 “obtaining” a communication may refer to receiving a transmission carrying the communication directly (for example, from the UE 120 to the network node 110) or receiving the communication (or information derived from reception of the communication) via one or more other network nodes or devices.

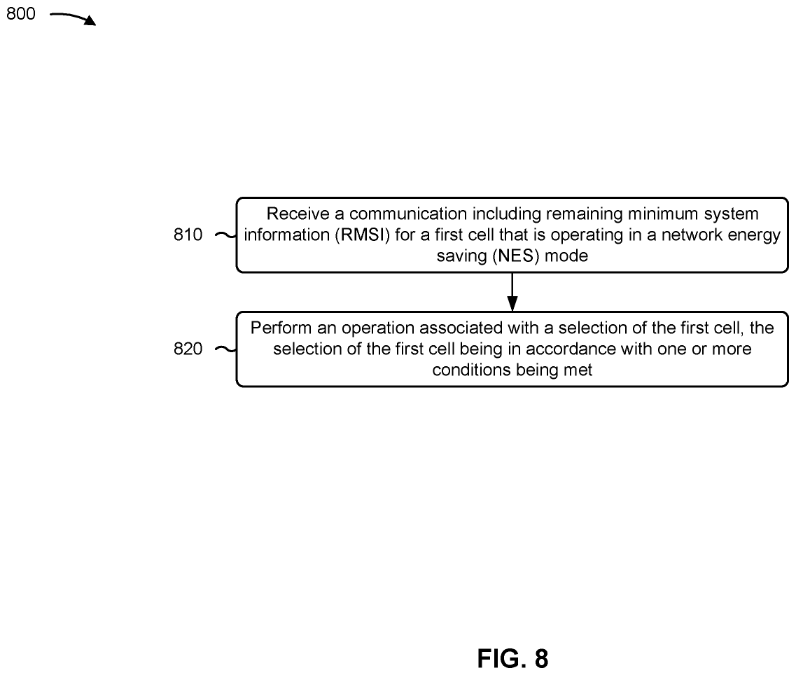

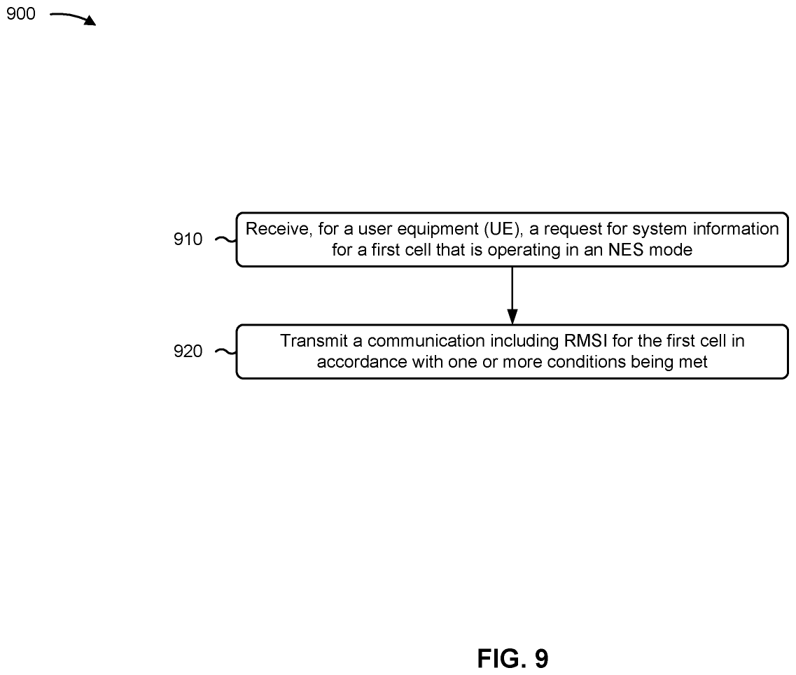

The network node 110, the controller/processor 240 of the network node 110, the UE 120, the controller/processor 280 of the UE 120, the CU 310, the DU 330, the RU 340, or any other component(s) of FIG. 1, 2, or 3 may implement one or more techniques or perform one or more operations associated with a system information operation for network energy saving, as described in more detail elsewhere herein. For example, the controller/processor 240 of the network node 110, the controller/processor 280 of the UE 120, any other component(s) of FIG. 2, the CU 310, the DU 330, or the RU 340 may perform or direct operations of, for example, process 800 of FIG. 8, process 900 of FIG. 9, or other processes as described herein (alone or in conjunction with one or more other processors). The memory 242 may store data and program codes for the network node 110, the network node 110, the CU 310, the DU 330, or the RU 340. The memory 282 may store data and program codes for the UE 120. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 110, the UE 120, the CU 310, the DU 330, or the RU 340, may cause the one or more processors to perform process 800 of FIG. 8, process 900 of FIG. 9, or other processes as described herein. In some examples, executing instructions may include running the instructions, converting the instructions, compiling the instructions, and/or interpreting the instructions, among other examples.

In some aspects, the UE 120 includes means for receiving a communication including RMSI (e.g., a SIB1) for a first cell that is operating in an NES mode (e.g., an NES cell); and/or means for performing an operation associated with a selection of the first cell, the selection of the first cell being in accordance with one or more conditions being met. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for receiving, for a UE, a request for system information for a first cell that is operating in an NES mode; and/or means for transmitting a communication including RMSI for the first cell in accordance with one or more conditions being met. The means for the network node 110 to perform operations described herein may include, for example, one or more of communication manager 150, transmit processor 214, TX MIMO processor 216, modem 232, antenna 234, MIMO detector 236, receive processor 238, controller/processor 240, memory 242, or scheduler 246.

As indicated above, FIG. 3 is provided as an example. Other examples may differ from what is described with regard to FIG. 3.

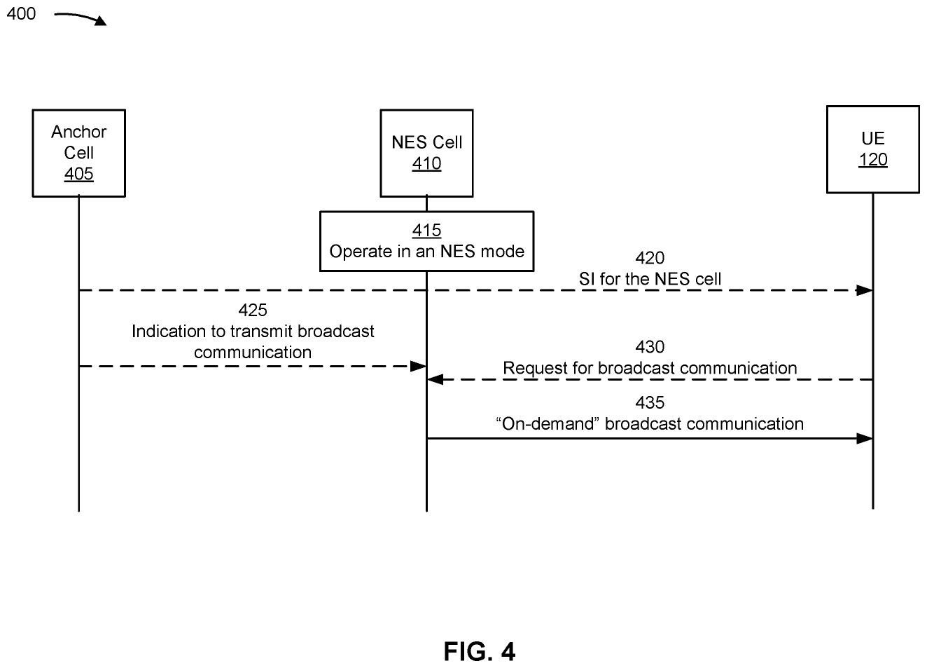

FIG. 4 is a diagram illustrating an example of an NES operation 400, in accordance with the present disclosure.

NES and/or network energy efficiency measures are expected to have increased importance in wireless network operations for various reasons, such as climate change mitigation, environmental sustainability, and/or network cost reduction, among other examples. For example, although NR generally offers a significant energy efficiency improvement per gigabyte over previous generations (for example, LTE), new NR use cases and/or the adoption of millimeter wave frequencies may require more network sites, more network antennas, larger bandwidths, and/or more frequency bands, among other examples, which may lead to more efficient wireless networks that nonetheless have higher energy requirements and/or cause more emissions than previous wireless network generations. Furthermore, energy accounts for a significant proportion of the cost to operate a wireless network. For example, according to some estimates, energy costs are about one-fourth the total cost to operate a wireless network, and over 90% of network operating costs are spent on energy (for example, fuel and electricity). The largest proportion of energy consumption and/or energy costs are associated with a radio access network (RAN), which accounts for about half of the energy consumption in a wireless network, with data centers and fiber transport accounting for smaller shares. Accordingly, measures to increase network energy savings and/or improve network energy efficiency are factors that may drive adoption and/or expansion of wireless networks.

One technique to increase energy efficiency in a RAN may be to enable a cell discontinuous transmission (C-DTX) and/or discontinuous reception (C-DRX) (C-DTX/DRX) mechanism, which may generally have similar characteristics as a discontinuous reception (DRX) configuration that may be configured for a UE 120. For example, the C-DTX/DRX mechanism may include an on duration (or active time), during which a network node 110 transmits and/or receives one or more channels or signals, and an opportunity for a network node 110 to enter a sleep state during a time when an entire cell (for example, including the network node 110 and any connected mode UEs 120) is sleeping.

Another technique to increase energy efficiency in a RAN may be to enable “on-demand” broadcast transmissions by a network node 110 and/or a cell. For example, to reduce power consumption at a network node 110, the network node 110 may transmit certain broadcast communications (e.g., system information communications, synchronization signal blocks (SSBs), and/or system information blocks (SIBs)) in an on-demand manner (e.g., rather than on a periodic basis or following a periodic schedule). In some examples, the on-demand communication may be a communication that carries remaining minimum system information (RMSI), such as a SIB type 1 (SIB1) or another SIB (e.g., as defined, or otherwise fixed, by a wireless communication standard, such as the 3GPP). For example, as used herein, “SIB1” or “SIB type 1” refers to a SIB that carries RMSI. In some examples, one or more SSBs and/or SIB1 may be transmitted via a cell to support initial access by UEs and measurement by UEs, among other examples. Typically, such communications are periodically transmitted via the cell (e.g., following some periodic schedule where the communications are transmitted one or more times each period). Therefore, one way to reduce network power consumption is to reduce a quantity of transmissions of such communications so that, for example, SSBs and SIB1s are transmitted less frequently by a cell operating in an NES mode (or NES state). As an example, SSBs and/or SIBs (e.g., SIB1) may be transmitted in an on-demand manner by a cell to conserve network power by the cell.

As shown in FIG. 4, an anchor cell 405, an NES cell 410, and a UE 120 may communicate with each other. As used herein, an “NES” cell (e.g., the NES cell 410) refers to a cell (or a network node 110) that is operating in an NES mode (or NES state). As used herein, an “anchor” cell (e.g., the anchor cell 405) refers to a cell (or network node 110) that is configured to assist and/or control operations of an NES cell. In some examples, the anchor cell 405 may be a primary cell (PCell) and the NES cell 410 may be a secondary cell (SCell). For example, in carrier aggregation, the UE 120 may be configured with a primary carrier or PCell and one or more secondary carriers or SCells. In some aspects, the PCell may carry control information (e.g., downlink control information and/or scheduling information) for scheduling data communications on one or more SCells. In some examples, the anchor cell 405 and the NES cell 410 may be associated with (e.g., controlled by or supported by) the same network node 110. In other examples, the anchor cell 405 and the NES cell 410 may be associated with (e.g., controlled by or supported by) different network nodes 110.

As shown by reference number 415, the NES cell 410 may operate in an NES mode. For example, the NES cell 410 may transmit one or more types of broadcast communications (e.g., SSBs and/or SIB1) in an on-demand manner. For example, when the NES cell 410 is not operating in the NES mode, the NES cell 410 may transmit the one or more types of broadcast communications periodically. However, to conserve power or energy resources, the NES cell 410 may transmit the one or more types of broadcast communications (e.g., SSBs and/or SIB1) in an on-demand manner when operating in the NES mode.

In some aspects, the UE 120 may be operating in an idle mode (e.g., an RRC idle mode) or an inactive mode (e.g., an RRC inactive mode). In other aspects, the UE 120 may be operating in a connected mode (e.g., an RRC connected mode). For example, the UE 120 may support a connected mode (e.g., an RRC connected mode), an idle mode (e.g., an RRC idle mode), and an inactive mode (e.g., an RRC inactive mode). The RRC connected mode may sometimes be referred to as an RRC active mode. The RRC inactive mode may functionally reside between the RRC connected mode and the RRC idle mode. The UE 120 may transition between different modes based at least in part on various commands and/or communications received from one or more network nodes 110. For example, the UE 120 may transition from RRC connected mode or RRC inactive mode to RRC idle mode based at least in part on receiving an RRCRelease communication. As another example, the UE may transition from RRC connected mode to RRC inactive mode based at least in part on receiving an RRCRelease with suspendConfig communication. As another example, the UE 120 may transition from RRC idle mode to RRC connected mode based at least in part on receiving an RRCSetupRequest communication. As another example, the UE 120 may transition from RRC inactive mode to RRC connected mode based at least in part on receiving an RRCResumeRequest communication. When transitioning to RRC inactive mode, the UE 120 and/or the one or more network nodes 110 may store a UE context (e.g., an access stratum (AS) context and/or higher-layer configurations). This enables the UE 120 and/or the one or more network nodes 110 to apply the stored UE context when the UE 120 transitions from RRC inactive mode to RRC connected mode in order to resume communications with the one or more network nodes 110, which reduces latency of transitioning to the RRC connected mode relative to transitioning to the RRC connected mode from RRC idle mode. When the UE 120 is operating in the RRC idle mode, the UE context may not be stored for the UE 120.

To support initial access and/or measurements of the NES cell 410, the UE 120 may receive one or more types of broadcast communications from the NES cell 410 (e.g., SSBs and/or SIB1). However, the NES cell 410 (e.g., operating in the NES mode) may not periodically transmit the one or more types of broadcast communications, or may transmit the one or more types of broadcast communications infrequently, thereby reducing opportunities for the UE 120 to access the NES cell 410 and/or to perform measurements of the NES cell 410.

In some examples, as shown by reference number 420, the anchor cell 405 may transmit, and the UE 120 may receive, system information (SI) for the NES cell 410. For example, the anchor cell 405 may transmit, and the UE 120 may receive, a copy of the SIB1 of the NES cell 410. As an example, the anchor cell 405 may transmit the copy of the SIB1 of the NES cell 410 as part of a SIB transmission or SSB transmission by the anchor cell 405. This enables the UE 120 to obtain RMSI for the NES cell 410 that may be used by the UE 120 to perform an initial access operation (e.g., a random access channel (RACH) operation or procedure) to establish a connection with the NES cell 410.

In some examples, the NES cell 410 may be triggered to transmit the one or more types of broadcast communications from the NES cell 410 (e.g., SSBs and/or SIB1). For example, as shown by reference number 425, the anchor cell 405 may transmit, and the NES cell 410 may receive, an indication to transmit one or more broadcast communications (e.g., SSBs and/or SIB1). For example, the anchor cell 405 may indicate to the NES cell 410 to transmit the SSBs and/or SIB1 via backhaul coordination (e.g., via a cell on or off indication via a backhaul link or a midhaul link). As another example, the anchor cell 405 may indicate to the NES cell 410 to transmit the SSBs and/or SIB1 via SCell activation or deactivation signaling.

Additionally, or alternatively, as shown by reference number 430, the UE 120 may transmit, and the NES cell 410 may receive, a request for one or more broadcast communications (e.g., SSBs and/or SIB1). In some examples, the UE 120 may transmit the request directly to the NES cell 410. In other examples, the UE 120 may transmit the request to the anchor cell 405 and the anchor cell may forward the request to the NES cell 410 (e.g., in an indication in a similar manner as described in connection with reference number 425). For example, the UE 120 may transmit an uplink communication indicating that the NES cell 410 is to transmit the one or more broadcast communications (e.g., SSBs and/or SIB1). In some examples, the request from the UE 120 may be included in an uplink wakeup signal (e.g., a cell wakeup signal) or another type of signal.

As shown by reference number 435, the NES cell 410 may transmit (and the UE 120 may receive) an “on-demand” broadcast communication, such as an on-demand SSB and/or an on-demand SIB1. For example, the NES cell 410 may transmit the broadcast communication based on, in response to, or otherwise associated with being triggered to transmit the broadcast communication (e.g., by the anchor cell as described in connection with reference number 425 or by the UE 120 as described in connection with reference number 430). As a result, the UE 120 may be enabled to obtain system information (e.g., RMSI) to enable the UE 120 to perform an initial access operation (e.g., a RACH operation or procedure) to establish a connection with the NES cell 410. Additionally, or alternatively, the UE 120 may measure the broadcast communication(s) to obtain measurement information for the NES cell 410 (e.g., which may be used to improve mobility operations, handover operations, or other operations associated with the UE 120).

Although the UE 120 may obtain system information and/or measurement information for the NES cell 410 via one or more on-demand communications, the UE 120 may be enabled to establish a connection with the NES cell 410, to camp on the NES cell 410, and/or to request system information for the NES cell 410 without limitations. As a result, an efficiency or effectiveness of the NES mode of the NES cell 410 may be reduced. For example, the UE 120 may be enabled to establish a connection with the NES cell 410 without limitations, which may result in the NES cell 410 using additional power or energy to maintain or perform operations for the connection with the UE 120. As another example, the UE 120 may be enabled to select the NES cell 410 (e.g., camp on the NES cell 410). However, the NES cell 410 may not transmit certain communications frequently enough to support camping by the UE 120, resulting in reduced performance for the UE 120. As another example, the UE 120 may be enabled to transmit a request for system information from the NES cell 410 at any time and/or without limitations, which may result in the NES cell having to frequently transmit on-demand communications (e.g., in response to requests from one or more UEs 120). The frequent on-demand communications may consume power and/or energy resources of the NES cell 410, thereby reducing an efficiency or effectiveness of the NES mode.

As indicated above, FIG. 4 is provided as an example. Other examples may differ from what is described with regard to FIG. 4.

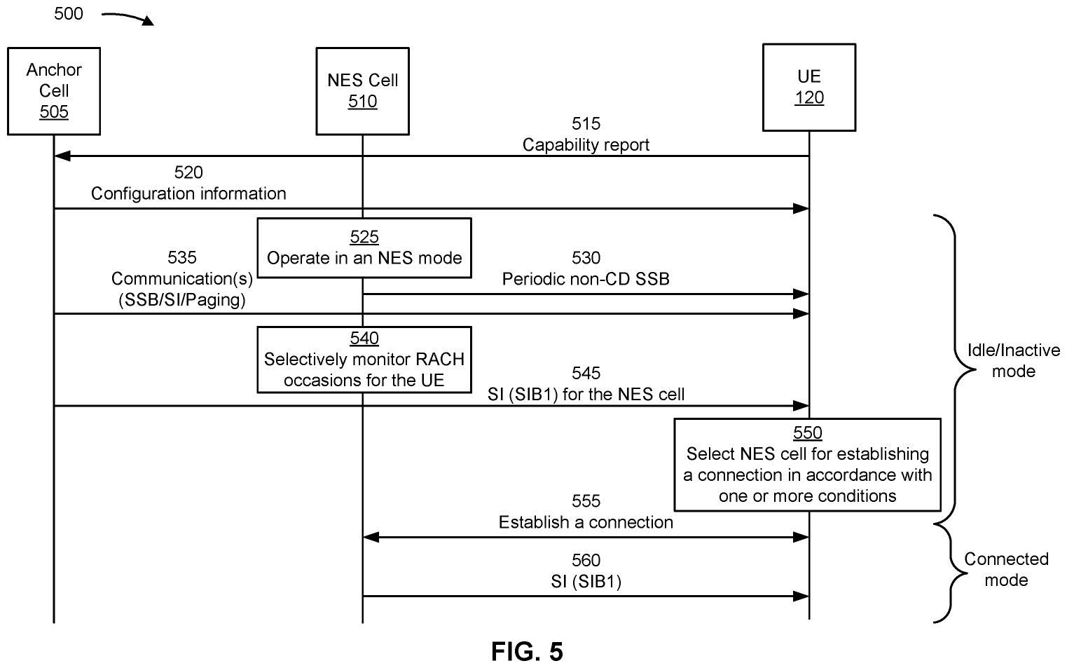

FIG. 5 is a diagram of an example 500 associated with a system information operation for network energy saving in accordance with the present disclosure. As shown in FIG. 5, an anchor cell 505 (e.g., a network node 110, a CU, a DU, and/or an RU) and/or an NES cell 510 (e.g., a network node 110, a CU, a DU, and/or an RU) may communicate with a UE 120. In some aspects, the anchor cell 505, the NES cell 510, and the UE 120 may be part of a wireless network (e.g., wireless network 100). The UE 120 and the anchor cell 505 may have established a wireless connection prior to operations shown in FIG. 5. In some aspects, the UE 120 may not have an active or connected RRC connection. For example, the UE 120 may be operating in an idle mode (e.g., an RRC idle mode or state) or an inactive mode (e.g., an RRC inactive mode or state), as shown in FIG. 5.

In some aspects, the anchor cell 505 may be a PCell and the NES cell 510 may be an SCell for the UE 120. In some aspects, the anchor cell 505 and the NES cell 510 may be associated with (e.g., controlled by or supported by) the same network node 110. In other aspects, the anchor cell 505 and the NES cell 510 may be associated with (e.g., controlled by or supported by) different network nodes 110.

In some aspects, as shown by reference number 515, the UE 120 may transmit, and the anchor cell 505 (and/or the NES cell 510) may receive, a capability report. The UE 120 may transmit the capability report via an uplink communication, a UE assistance information (UAI) communication, an uplink control information (UCI) communication, an uplink MAC control element (MAC-CE) communication, an RRC communication, a PUCCH, and/or a PUSCH, among other examples. The capability report may indicate one or more parameters associated with respective capabilities of the UE 120. The one or more parameters may be indicated via respective information elements (IEs) included in the capability report.

The capability report may indicate whether the UE 120 supports a feature and/or one or more parameters related to the feature. For example, the capability report may indicate a capability and/or parameter for selecting a cell (e.g., for camping and/or establishing a communication connection) operating in an NES mode (e.g., the NES cell 510) in accordance with one or more conditions. As another example, the capability report may indicate a capability and/or parameter for transmitting a request for system information of the NES cell 510 (e.g., via an uplink wakeup signal or another uplink communication). One or more operations described herein may be based on capability information of the capability report. For example, the UE 120 may perform a communication in accordance with the capability information, or may receive configuration information that is in accordance with the capability information.

As shown by reference number 520, the anchor cell 505 (or the NES cell 510) may transmit, and the UE 120 may receive, configuration information. In some aspects, the UE 120 may receive the configuration information via one or more of system information (e.g., a master information block (MIB) and/or a SIB, among other examples), RRC signaling, MAC signaling (e.g., one or more MAC-CEs), and/or DCI, among other examples. In some aspects, the UE 120 may receive the configuration information while operating in a connected mode (e.g., via dedicated signaling, such as RRC signaling). In other aspects, the UE 120 may receive the configuration information while operating in the idle mode or the inactive mode (e.g., via broadcast signaling, system information signaling, or other signaling).

In some aspects, the configuration information may indicate one or more candidate configurations and/or communication parameters. In some aspects, the one or more candidate configurations and/or communication parameters may be selected, activated, and/or deactivated by a subsequent indication. For example, the subsequent indication may select a candidate configuration and/or communication parameter from the one or more candidate configurations and/or communication parameters. In some aspects, the subsequent indication (e.g., an indication described herein) may include a dynamic indication, such as one or more MAC-CEs and/or one or more DCI messages, among other examples.

In some aspects, the configuration information may indicate that the UE 120 is to select NES cells (e.g., the NES cell 510) for establishing a connection (e.g., an RRC connection) or for camping in accordance with one or more conditions, as described in more detail elsewhere herein. In some aspects, the configuration information may indicate the one or more conditions. Additionally, or alternatively, the one or more conditions may be stored by the UE 120 (e.g., via an original equipment manufacturer (OEM) configuration), such as when the one or more conditions are defined, or otherwise fixed, by a wireless communication standard (such as the 3GPP).

The UE 120 may configure itself based at least in part on the configuration information. In some aspects, the UE 120 may be configured to perform one or more operations described herein based at least in part on the configuration information.

In some aspects, the configuration information described in connection with reference number 520 and/or the capability report described in connection with reference number 515 may include information transmitted via multiple communications. Additionally, or alternatively, the anchor cell 505 (or the NES cell 510) may transmit the configuration information, or a communication including at least a portion of the configuration information, before and/or after the UE 120 transmits the capability report. For example, the anchor cell 505 (or the NES cell 510) may transmit a first portion of the configuration information before the UE 120 transmits the capability report, the UE 120 may transmit at least a portion of the capability report, and the anchor cell 505 (or the NES cell 510) may transmit a second portion of the configuration information after receiving the capability report.

As shown by reference number 525, the NES cell 510 may operate in an NES mode. For example, the NES cell 510 may transmit one or more types of broadcast communications (e.g., SSBs and/or SIB1) in an on-demand manner. For example, when the NES cell 510 is not operating in the NES mode, the NES cell 510 may transmit the one or more types of broadcast communications periodically. However, to conserve power or energy resources, the NES cell 510 may transmit the one or more types of broadcast communications (e.g., SSBs and/or SIB1) in an on-demand manner and/or less frequently (e.g., as compared to when the NES cell 510 is not operating in the NES mode) when operating in the NES mode. In some aspects, the NES cell 510 may be configured to dynamically switch between operating in the NES mode and not operating in the NES mode, such as based on or otherwise associated with a network load for the NES cell 510. In other aspects, the NES cell 510 may always operate in the NES mode.

In some aspects, as shown by reference number 530, the NES cell 510 (when operating in the NES mode) may transmit one or more periodic communications, such as a non-cell-defining (NCD) SSB. As used herein, a “cell-defining (CD) SSB” refers to an SSB that indicates a SIB message including an identifier associated with the cell (e.g., an NR cell global identity (NCGI)). In some aspects, a CD-SSB may carry system information, such as RMSI. For example, the SIB included in the CD-SSB may be a SIB1, as defined or otherwise fixed by a wireless communication standard, such as the 3GPP. In some aspects, the CD-SSB may enable RMSI acquisition. “non-cell-defining SSB” (NCD-SSB) refers to an SSB that does not indicate the SIB message and/or indicates a SIB message not including the identifier associated with the cell. For example, an NCD-SSB may not include SIB1 or RMSI. The NES cell 510 may periodically transmit one or more NCD-SSBs while operating in the NES mode (e.g., because the NCD-SSBs use less energy to transmit than CD-SSBs and/or SIB1).

In some aspects, the NES cell 510 may transmit via a broadcast channel (e.g., a physical broadcast channel (PBCH)). The PBCH (e.g., a payload of the PBCH) of the NES cell 510 may include information to enable UEs to acquire system information (e.g., SIB1) of the NES cell 510. For example, the PBCH (e.g., a payload of the PBCH) of the NES cell 510 may indicate one or more frequency resources (e.g., a raster) of anchor cells (e.g., the anchor cell 505) via which the UE(s) can obtain or request SIB1 of the NES cell 510. In some aspects, the PBCH (e.g., a payload of the PBCH) of the NES cell 510 may indicate identifiers of one or more anchor cells (e.g., the anchor cell 505) via which the UE(s) can obtain or request SIB1 of the NES cell 510. For example, one or more most significant bits (MSBs) or one or more least significant bits (LSBs) of the identifiers May be indicated via the PBCH of the NES cell 510. In some aspects, the PBCH (e.g., a payload of the PBCH) of the NES cell 510 may indicate an area identifier of the NES cell 510 and/or of the anchor cell(s).

In some aspects, the PBCH (e.g., a payload of the PBCH) of the NES cell 510 may indicate information for acquiring the SIB1 of the NES cell 510 via the anchor cell 505. For example, the PBCH of the NES cell 510 may indicate whether the anchor cell 505 broadcasts the SIB1 of the NES cell 510. If the anchor cell 505 broadcasts the SIB1 of the NES cell 510, then the PBCH of the NES cell 510 may indicate a PDCCH configuration for the system information broadcast by the anchor cell 505. In some aspects, the PBCH (e.g., a payload of the PBCH) of the NES cell 510 may indicate a PDCCH configuration of a SIB1 of the anchor cell 505 (e.g., where the SIB1 of the anchor cell 505 includes a configuration for acquiring the SIB1 of the NES cell 510). In some aspects, the PBCH (e.g., a payload of the PBCH) of the NES cell 510 may indicate whether the anchor cell 505 transmits the SIB1 of the NES cell 510 in an on-demand manner. If the anchor cell 505 transmits the SIB1 of the NES cell 510 in an on-demand manner, then the PBCH of the NES cell 510 may indicate one or more resources and/or a configuration of the one or more resources available for the UE 120 to transmit a request for the SIB1 to the anchor cell 505 (e.g., the PBCH of the NES cell 510 may indicate an uplink wakeup signal configuration for resources that the UE 120 may use to transmit a request to the anchor cell 505 for the SIB1 of the NES cell 510).

In some aspects, the UE 120 may receive an indication that the NES cell 510 transmits SIB1 in an on-demand manner (e.g., via the NES cell 510 or via the anchor cell 505). The indication that the NES cell 510 transmits SIB1 in an on-demand manner may be included in an indication that there is no CD-SSB for the NES cell 510. The UE 120 may discover an anchor cell (e.g., the anchor cell 505) from which the UE 120 can acquire a configuration for requesting the SIB1 of the NES cell 510. In such examples, the anchor cell 505 may transmit an RMSI PDCCH configuration for the NES cell 510. As another example, a MIB of the NES cell 510 may indicate the RMSI PDCCH configuration for the NES cell 510 and indicate that RMSI transmissions (e.g., SIB1 transmissions) are on-demand. For example, a given value of a parameter for a gap between Subcarrier 0 of synchronization signal (SS)/PBCH block and a common resource block (e.g., a k_SSB parameter) in the MIB of the NES cell 510 may be used to indicate that RMSI transmissions (e.g., SIB1 transmissions) are on-demand for the NES cell 510.

The UE 120 may camp on the anchor cell 505. “Camping” on a cell or network node may refer to the UE 120 monitoring broadcasts from a cell (for example, monitoring a control channel associated with the cell or the network node) to maintain readiness to actively connect with the cell or network node and utilize the wireless communication system. For example, UEs may camp on a cell of a wireless communication network and silently monitor or receive periodic broadcasting of signals, such as SIBs and SSBs, without a network node associated with the cell being aware of the camping UE. A UE that has selected a cell and that is monitoring the control channel of the cell is said to be “camped” on the cell. For example, while operating in the idle mode or the inactive mode, the UE 120 may monitor a control channel or a broadcast channel of the anchor cell 505 (e.g., the UE 120 may camp on the anchor cell 505).

As shown by reference number 535, the anchor cell 505 may transmit, and the UE 120 may receive, one or more communications (e.g., broadcast communications and/or periodic communications). For example, the anchor cell 505 may transmit, and the UE 120 may receive, one or more SSBs, system information (e.g., a MIB and/or one or more SIBs), and/or a paging communication, among other examples. A paging communication may indicate that the network (e.g., the anchor cell 505 or another network node) has downlink traffic to transmit to the UE 120. For example, a paging communication may be a broadcast communication that includes an identifier of the UE 120 and indicates that the UE 120 is to establish a communication connection to enable the UE 120 to receive downlink traffic or perform another operation.

In some aspects, as shown by reference number 540, the NES cell 510 may selectively monitor RACH occasions for the UE 120 (e.g., while operating in the NES mode). For example, the NES cell 510 may refrain from monitoring RACH occasions associated with the UE 120 unless there is a paging communication that has been transmitted for the UE 120. For example, the monitoring of RACH occasions by the NES cell 510 may be conditioned on the UE 120 being paged. For example, a RACH operation may be performable in association with the UE 120 receiving a paging communication because the NES cell 510 may only monitor RACH occasions if the NES cell detects or receives an indication that a UE (e.g., the UE 120) is being paged. This may conserve network energy or power resources that would have otherwise been used by the NES cell 510 when no UEs were being paged (e.g., when there is no downlink traffic for idle or inactive UEs in a geographic area covered by or near the NES cell 510). For example, if no UEs are being paged, a likelihood that a UE is transmitting a RACH communication (e.g., a message 1 or Msg1) via a RACH occasion is reduced. Therefore, to conserve power and/or energy, the NES cell 510 may refrain from monitoring the RACH occasions when no UEs are being paged in a geographic area covered by or near the NES cell 510 (e.g., the NES cell 510 may only monitor RACH occasions if the NES cell 510 receives or detects a paging communication).

In some aspects, as shown by reference number 545, the anchor cell 505 may transmit, and the UE 120 may receive, system information for the NES cell 510, such as a SIB1 and/or RMSI, among other examples. For example, the anchor cell 505 may broadcast the RMSI (e.g., the SIB1) of the NES cell 510. As a result, the NES cell 510 may refrain from transmitting (or broadcasting) the RMSI (e.g., the SIB1) while the NES cell 510 is operating in the NES mode, thereby conserving energy and/or power of the NES cell 510. In some aspects, the anchor cell may transmit the RMSI (e.g., the SIB1) of the NES cell 510 via a SIB that is associated with (e.g., dedicated for) providing the SIB1 of NES cells. For example, a type of SIB may be defined (e.g., by a wireless communication standard, such as the 3GPP) for indicating system information of cells operating in the NES mode. The anchor cell 505 may transmit the RMSI (e.g., the SIB1) of the NES cell 510 using this type of SIB. As another example, the anchor cell 505 may transmit the RMSI (e.g., the SIB1) of the NES cell 510 via a SIB of the anchor cell. For example, the anchor cell may transmit a SIB that includes first RMSI for the anchor cell 505 and second RMSI for the NES cell 510. In other words, the anchor cell 505 may transmit the RMSI (e.g., the SIB1) of the NES cell 510 via an extended SIB1 that includes RMSI of both the anchor cell 505 and the NES cell 510.

In some aspects, the anchor cell 505 may transmit the RMSI (e.g., the SIB1) of the NES cell 510 in an on-demand communication (e.g., in response to receiving a request for the RMSI (e.g., the SIB1) of the NES cell 510). For example, the UE 120 may transmit, and the anchor cell 505 may receive, a request for the RMSI (e.g., the SIB1) of the NES cell 510, such as via an uplink RACH message (e.g., a Msg1 or a Msg3) or another uplink communication. The anchor cell 505 may transmit, and the UE 120 may receive, the RMSI (e.g., the SIB1) of the NES cell 510 (e.g., based on, in response to, or otherwise associated with the UE 120 transmitting the request).

As shown by reference number 550, the UE 120 may select the NES cell for establishing a connection in accordance with one or more conditions (or criteria). For example, the UE 120 may perform an operation associated with a selection of the NES cell 510, such as transmitting a RACH message or another initial access message to initiate the establishment of a communication connection with the NES cell 510. The one or more conditions may define criteria to be used by the UE 120 when determining whether the UE 120 can establish a connection with the NES cell 510. As a result, the UE 120 may attempt to establish a connection with the NES cell 510 only in certain scenarios or under allowable conditions. As a result, an effectiveness and/or efficiency of the NES mode may be improved because the UE 120 may only attempt to establish a connection with the NES cell 510 when the one or more conditions indicate that establishing the connection is allowable (e.g., rather than the UE 120 establishing the connection without limitations or restrictions).

The one or more conditions may include signal quality and/or signal strength conditions that are associated with (e.g., specific to or defined for) NES cells. The signal quality and/or signal strength conditions may be more stringent than signal quality and/or signal strength conditions used for selecting cells that are not operating in the NES mode. In other words, the UE 120 may follow more stringent quality/strength conditions when selecting the NES cell 510 for establishing a communication connection. The signal quality and/or signal strength conditions that are associated with (e.g., specific to or defined for) NES cells may be indicated by one or more offsets (e.g., an offset value from another signal quality and/or signal strength conditions configured for the UE 120) and/or one or more thresholds. For example, the signal quality and/or signal strength conditions that are associated with (e.g., specific to or defined for) NES cells may configured by the anchor cell 505.

In some aspects, the one or more conditions may include a type or category of the UE 120. For example, establishing a connection with an NES cell may be supported for only some UEs (e.g., some types or categories of UE). For example, the one or more conditions may indicate one or more allowable types of UE, one or more allowable categories of UE, and/or one or more allowable subscriptions, among other examples. For example, the UE 120 may be associated with a subscription that is defined or configured by a mobile network operator. In some aspects, only some types or levels of subscriptions may be allowed to establish a connection with the NES cell.

In some aspects, the one or more conditions may include the UE 120 receiving explicit network authorization to establish the connection with the NES cell 510. For example, the anchor cell 505 (or another network node 110) may transmit, and the UE 120 may receive, an indication that the UE 120 is authorized to access the NES cell. For example, the UE 120 may receive authorization to connect with NES cells. The UE 120 may receive the authorization while the UE 120 is operating in a connected mode. For example, the UE 120 may transmit, and the anchor cell 505, the NES cell 510, or another network node may receive, a capability, type, and/or subscription of the UE 120. Additionally, the UE 120 may transmit a request to use a feature of establishing connections with NES cells. The network (e.g., the anchor cell 505, the NES cell 510, or another network node) may transmit, and the UE 120 may receive, the indication of whether the UE 120 is authorized to use this feature (e.g., an indication of whether the UE 120 is allowed to establish a connection with cells that are not currently transmitted SIB1, such as the NES cell 510).

In some aspects, the one or more conditions may include the UE 120 being paged. For example, as described elsewhere herein, the UE 120 may receive a paging communication (e.g., from the anchor cell 505). The UE 120 may be allowed to establish a connection with the NES cell 510 only when the UE 120 is being paged. In other words, if the UE 120 has uplink traffic to transmit, then the UE 120 may refrain from establishing a connection with the NES cell 510. For example, if the UE 120 has uplink traffic to transmit, then the UE 120 may establish a connection with the anchor cell 505. However, if the UE 120 receives a paging communication, then the UE 120 may be allowed to establish a connection with the NES cell 510 (e.g., in accordance with one or more other conditions described herein). In some aspects, the UE 120 may be directed to, or authorized to, establish a connection with the NES cell 510 in association with the paging communication. For example, the UE 120 may receive a paging redirection communication that indicates that the UE 120 is directed to or authorized to establish a connection with NES cells, such as the NES cell 510. Additionally, as described elsewhere herein, the NES cell 510 may only monitor RACH occasions if a UE is being paged. Therefore, a RACH operation or procedure may be performable based on, in response to, or otherwise associated with the UE 120 being paged.

In some aspects, the one or more conditions may include one or more allowable traffic types and/or one or more allowable quality of service (QOS) classes or QoS types, among other examples. For example, the UE 120 may be allowed to establish a connection with the NES cell 510 only for the allowable traffic type(s), allowable QoS class(es), and/or allowable QoS type(s), among other examples. The UE 120 may receive an indication of the allowable traffic type(s), allowable QoS class(es), and/or allowable QoS type(s), among other examples, such as when the UE 120 has an active connection with the network and/or via a broadcast communication (such as from the anchor cell 505). For example, when the UE 120 has uplink traffic to transmit (and the UE 120 is in the idle mode or the inactive mode), the UE 120 may select a cell for establishing a connection. In selecting the NES cell 510, the UE 120 may only select the NES cell 510 if the uplink traffic is one of the allowable traffic type(s), allowable QoS class(es), and/or allowable QoS type(s), among other examples. As an example, the UE 120 may be allowed to establish a connection with the NES cell 510 only for high priority uplink traffic or for low latency uplink traffic, among other examples. For other types of uplink traffic, the UE 120 may refrain from selecting NES cells for establishing the connection (e.g., the UE 120 may select the anchor cell for other types of uplink traffic).

In some aspects, the one or more conditions may include one or more allowable purposes (and/or one or more disallowed purposes) for establishing the connection. For example, the UE 120 may be allowed to select the NES cell 510 only for one or more allowable purposes. In some aspects, the one or more conditions may include one or more disallowed purposes (e.g., purposes for which the UE 120 is not permitted to select NES cells for establishing a connection). As an example, the UE 120 may not be permitted or allowed to select NES cells for location update operations, location registration operations, RAN notification area (RNA) change operations, and/or tracking area (TA) change operations, among other examples. If the UE 120 is establishing a connection for a disallowed purpose, then the UE 120 may refrain from selecting the NES cell 510 for establishing the connection.

In some aspects, as shown by reference number 555, the UE 120 and the NES cell 510 may establish a connection (e.g., an RRC connection). For example, the UE 120 may select the NES cell 510 based on, in response to, or otherwise associated with the one or more conditions being met or satisfied. For example, the UE 120 may perform an operation in association with selecting the NES cell 510, such as transmitting a RACH communication or initial access communication. For example, the UE 120 may transmit a Msg1 or MsgA of a RACH procedure (e.g., via a RACH occasion associated with the NES cell 510, such as indicated by the RMSI or other system information of the NES cell 510) to initiate establishing the connection with the NES cell 510. The UE 120 and the NES cell 510 may perform the RACH procedure to establish the connection. For example, the UE 120 may transition to a connected mode (e.g., an RRC connected mode) based on, in response to, as a part of, or otherwise associated with establishing the connection with the NES cell 510.

In some aspects, as shown by reference number 560, the NES cell 510 may transmit, and the UE 120 may receive, system information (such as the SIB1, RMSI, or other system information of the NES cell 510). For example, the NES cell 510 may transmit the system information in a dedicated communication (or unicast communication) to the UE 120. As another example, the NES cell 510 may activate the broadcasting of the system information based on, in response to, or otherwise associated with establishing the connection with the UE 120.

As indicated above, FIG. 5 is provided as an example. Other examples may differ from what is described with respect to FIG. 5.

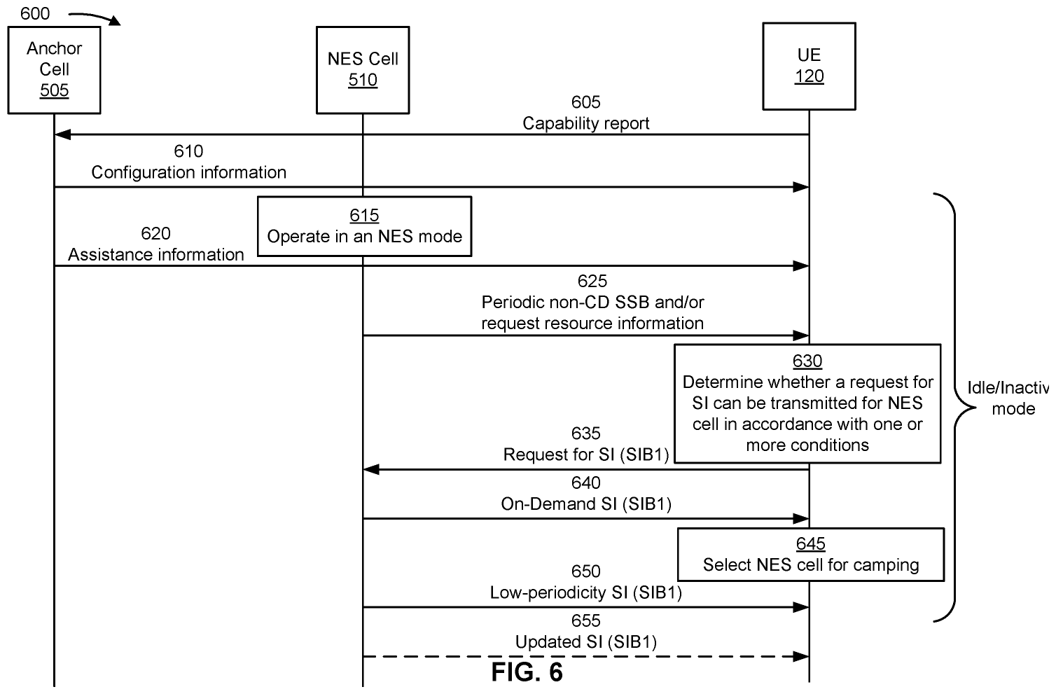

FIG. 6 is a diagram of an example 600 associated with a system information operation for network energy saving in accordance with the present disclosure. As shown in FIG. 6, the anchor cell 505 (e.g., a network node 110, a CU, a DU, and/or an RU) and/or the NES cell 510 (e.g., a network node 110, a CU, a DU, and/or an RU) may communicate with the UE 120. In some aspects, the anchor cell 505, the NES cell 510, and the UE 120 may be part of a wireless network (e.g., wireless network 100). The UE 120 and the anchor cell 505 may have established a wireless connection prior to operations shown in FIG. 6. In some aspects, the UE 120 may not have an active or connected RRC connection. For example, the UE 120 may be operating in an idle mode (e.g., an RRC idle mode or state) or an inactive mode (e.g., an RRC inactive mode or state), as shown in FIG. 6.

In some aspects, as shown by reference number 605, the UE 120 may transmit, and the anchor cell 505 (and/or the NES cell 510) may receive, a capability report. The UE 120 may transmit the capability report via an uplink communication, a UAI communication, an UCI communication, an uplink MAC-CE communication, an RRC communication, a PUCCH, and/or a PUSCH, among other examples. The capability report may indicate one or more parameters associated with respective capabilities of the UE 120. The one or more parameters may be indicated via respective IEs included in the capability report.

The capability report may indicate whether the UE 120 supports a feature and/or one or more parameters related to the feature. For example, the capability report may indicate a capability and/or parameter for selecting a cell (e.g., for camping and/or establishing a communication connection) operating in an NES mode (e.g., the NES cell 510) in accordance with one or more conditions. For example, the capability report may indicate whether the UE 120 supports camping on NES cells. As another example, the capability report may indicate a capability and/or parameter for transmitting a request for system information of the NES cell 510 (e.g., via an uplink wakeup signal or another uplink communication). One or more operations described herein may be based on capability information of the capability report. For example, the UE 120 may perform a communication in accordance with the capability information, or may receive configuration information that is in accordance with the capability information.

As shown by reference number 610, the anchor cell 505 (or the NES cell 510) may transmit, and the UE 120 may receive, configuration information. In some aspects, the UE 120 may receive the configuration information via one or more of system information (e.g., a MIB and/or a SIB, among other examples), RRC signaling, MAC signaling (e.g., one or more MAC-CEs), and/or DCI, among other examples. In some aspects, the UE 120 may receive the configuration information while operating in a connected mode (e.g., via dedicated signaling, such as RRC signaling). In other aspects, the UE 120 may receive the configuration information while operating in the idle mode or the inactive mode (e.g., via broadcast signaling, system information signaling, or other signaling).

In some aspects, the configuration information may indicate one or more candidate configurations and/or communication parameters. In some aspects, the one or more candidate configurations and/or communication parameters may be selected, activated, and/or deactivated by a subsequent indication. For example, the subsequent indication may select a candidate configuration and/or communication parameter from the one or more candidate configurations and/or communication parameters. In some aspects, the subsequent indication (e.g., an indication described herein) may include a dynamic indication, such as one or more MAC-CEs and/or one or more DCI messages, among other examples.

In some aspects, the configuration information may indicate that the UE 120 is to select NES cells (e.g., the NES cell 510) for establishing a connection (e.g., an RRC connection) or for camping in accordance with one or more conditions, as described in more detail elsewhere herein. In some aspects, the configuration information may indicate the one or more conditions. Additionally, or alternatively, the one or more conditions may be stored by the UE 120 (e.g., via an OEM configuration), such as when the one or more conditions are defined, or otherwise fixed, by a wireless communication standard (such as the 3GPP).

The UE 120 may configure itself based at least in part on the configuration information. In some aspects, the UE 120 may be configured to perform one or more operations described herein based at least in part on the configuration information.

In some aspects, the configuration information described in connection with reference number 610 and/or the capability report described in connection with reference number 605 may include information transmitted via multiple communications. Additionally, or alternatively, the anchor cell 505 (or the NES cell 510) may transmit the configuration information, or a communication including at least a portion of the configuration information, before and/or after the UE 120 transmits the capability report. For example, the anchor cell 505 (or the NES cell 510) may transmit a first portion of the configuration information before the UE 120 transmits the capability report, the UE 120 may transmit at least a portion of the capability report, and the anchor cell 505 (or the NES cell 510) may transmit a second portion of the configuration information after receiving the capability report.

As shown by reference number 615, the NES cell 510 may operate in an NES mode. For example, the NES cell 510 may transmit one or more types of broadcast communications (e.g., SSBs and/or SIB1) in an on-demand manner. For example, when the NES cell 510 is not operating in the NES mode, the NES cell 510 may transmit the one or more types of broadcast communications periodically. However, to conserve power or energy resources, the NES cell 510 may transmit the one or more types of broadcast communications (e.g., SSBs and/or SIB1) in an on-demand manner and/or less frequently (e.g., as compared to when the NES cell 510 is not operating in the NES mode) when operating in the NES mode. In some aspects, the NES cell 510 may be configured to dynamically switch between operating in the NES mode and not operating in the NES mode, such as based on or otherwise associated with a network load for the NES cell 510. In other aspects, the NES cell 510 may always operate in the NES mode.

In some aspects, the UE 120 may be connected to the NES cell 510 prior to the NES cell operating in the NES mode. For example, the UE 120 may be connected to the NES cell 510 while the NES cell is operating in an active mode or a non-NES mode. The UE 120 may transition to the idle or inactive state. Prior to releasing or suspending an RRC connection with the UE 120, the NES cell 510 may transmit, and the UE 120 may receive, assistance information associated with accessing the network if the NES cell switches to operating in the NES mode (e.g., if the cell adopts an NES feature). The assistance information may include a configuration for one or more resources available for the UE 120 to use to transmit requests for system information (e.g., RMSI or SIB1) of NES cells, such as an uplink wakeup signal configuration (e.g., as described in more detail elsewhere herein). The assistance information may include one or more frequencies and/or identifiers of other cells (such as the anchor cell 505) that are configured to assist the UE 120 with access (such as cells configured to provide a copy of system information for the NES cell 510 or providing other assistance or system information as described herein). The assistance information may include NES mode information, such as a schedule (e.g., a start time, an end time, and/or a duration) of the NES cell 510 operating in the NES mode.

The UE 120 may receive a resource configuration for one or more resources (e.g., time domain resources, frequency domain resources, and/or spatial domain resources) available for the UE 120 to use to transmit requests for system information (e.g., RMSI or SIB1) of NES cells, such as the NES cell 510. The UE 120 may receive the resource configuration from the anchor cell 505 (e.g., via assistance information), from the NES cell 510, and/or from a combination of signaling from the anchor cell 505 and the NES cell 510.

For example, as shown by reference number 620, the anchor cell 505 may transmit, and the UE 120 may receive assistance information. The assistance information may indicate one or more resources and/or configuration information for one or more resources available for the UE 120 to transmit requests (or demands) for system information (e.g., RMSI or SIB1) of NES cells, such as the NES cell 510. The resources may be uplink resources. In some aspects, the resources may be uplink wakeup signal resources. For example, the assistance information may include an uplink wakeup signal configuration.

In some aspects, as shown by reference number 625, the NES cell 510 (when operating in the NES mode) may transmit one or more periodic communications, such as an NCD SSB. The NES cell 510 may periodically transmit one or more NCD-SSBs while operating in the NES mode (e.g., because the NCD-SSBs use less energy to transmit than CD-SSBs and/or SIB1). Additionally, or alternatively, the NES cell 510 may transmit information associated with the one or more resources and/or configuration information for one or more resources available for the UE 120 to transmit requests (or demands) for system information (e.g., RMSI or SIB1) of NES cells. For example, the NES cell 510 may transmit, and the UE 120 may receive, an indication of the one or more resources and/or configuration information for one or more resources available for the UE 120 to transmit requests (or demands) for system information (e.g., RMSI or SIB1) of NES cells. As another example, the NES cell 510 may transmit monitoring information associated with the one or more resources (e.g., uplink wakeup signal resources). For example, the monitoring information may indicate which resources, from the one or more resources, are being monitored (e.g., actively) by the NES cell 510. For example, the monitoring information may indicate which resources, from the one or more resources, should be used by the UE 120 to request (or demand) system information from the NES cell 510.

As shown by reference number 630, the UE 120 may determine whether a request (or demand) for system information can be transmitted in accordance with one or more conditions. For example, the UE 120 may select the NES cell 510 for obtaining system information in accordance with the one or more conditions. The one or more conditions may be similar to (or the same as) the conditions described in connection with FIG. 5 and/or reference number 550. For example, the conditions may be associated with defining scenarios in which the UE 120 is allowed to transmit a request for the system information for the NES cell (e.g., is allowed to transmit an uplink wakeup signal to, or for, the NES cell 510). As a result, the UE 120 may only transmit the request if the one or more conditions are met or satisfied. This may reduce the quantity of requests for system information received by the NES cell 510, thereby reducing the quantity of on-demand communications (e.g., on-demand SIB1s) transmitted by the NES cell 510 while operating in the NES mode. The reduced quantity of on-demand communications may conserve power and/or energy of the NES cell 510 and/or improve the effectiveness or efficiency of the NES mode.

As shown by reference number 635, the UE 120 may transmit, and the NES cell 510 may receive, a request for system information (e.g., RMSI or a SIB1) of the NES cell 510. For example, the UE 120 may transmit the request using a resource that is configured for the UE 120 and/or that is monitored by the NES cell 510. The request may be included in an uplink communication, such as an uplink wakeup signal or another uplink communication. The UE 120 may transmit the request based on, in response to, or otherwise associated with the one or more conditions being met or satisfied, as described in more detail elsewhere herein.

The NES cell 510 may receive the request from the UE 120. The NES cell may determine that system information (e.g., RMSI or SIB1) is to be transmitted to the UE 120. As shown by reference number 640, the NES cell 510 may transmit, and the UE 120 may receive, an on-demand system information communication, such as an on-demand SIB1. The NES cell 510 may transmit the on-demand system information communication based on, in response to, or otherwise associated with receiving the request from the UE 120. In other words, the request from the UE 120 may trigger the NES cell 510 to transmit the on-demand system information communication.

As shown by reference number 645, the UE 120 may select the NES cell 510 for camping. For example, the UE 120 may perform an action associated with selecting the NES cell 510 for camping, such as monitoring a control channel or broadcast channel of the NES cell 510. In some aspects, the UE 120 may select the NES cell 510 for camping based on or otherwise associated with the NES cell 510 supporting camping (e.g., as indicated by the anchor cell 505 (such as in the assistance information) or as indicated by the NES cell 510 (such as at a prior time when the UE 120 had an active communication connection with the NES cell 510)).

For example, to support camping, the NES cell 510 may support SIB1 (e.g., RMSI) being transmitted on an infrequent basis (e.g., as compared to how frequently the SIB1 is transmitted for non-NES cells). For example, as shown by reference number 650, the NES cell 510 may transmit low-periodicity system information (e.g., SIB1) communications. The low-periodicity system information communications may have a first periodicity and system information communications transmitted by the NES cell 510 (e.g., when not operating in the NES mode) may have a second periodicity. The first periodicity may indicate that the NES cell is to transmit the system information communications less frequently than as indicated by the second periodicity.

For example, the UE 120 may be configured with an DRX cycle, such as an idle mode (I-DRX) cycle if the UE 120 is operating in the idle mode. The DRX cycle may be associated with a period that includes an inactive time. The inactive time may have a duration and a periodicity (e.g., defining a period for the DRX cycle). The DRX cycle may include one or more active times during which the UE 120 is to monitor for communications. The one or more active times may include paging occasions or other communication occasions configured for the DRX cycle. The NES cell 510 may transmit the low-periodicity or infrequent system information (e.g., SIB1) communications one or more times (e.g., N times) within each DRX (e.g., I-DRX) cycle. For example, the NES cell 510 may transmit the low-periodicity or infrequent system information (e.g., SIB1) communications N periods prior to a paging occasion in the I-DRX cycle. This enables a UE 120 camping on the NES cell 510 to receive system information close to a time at which the UE 120 may be paged by the network, thereby improving a likelihood that the UE 120 has system information available to be used to access the network if the UE 120 is paged during a paging occasion.

The UE 120 may receive an indication of one or more configuration parameters for the low-periodicity or infrequent system information (e.g., SIB1) communications. The UE 120 may receive the one or more configuration parameters from the NES cell 510, the anchor cell 505, or from another network node 110. In some aspects, the UE 120 may receive the one or more configuration parameters while the UE 120 is operating in a connected mode (e.g., before transitioning to the idle mode or the inactive mode). The one or more configuration parameters may include a periodicity, an offset, a quantity of repetitions, and/or spatial domain information (e.g., indicating one or more beams or beam directions in which the low-periodicity or infrequent system information communications are broadcast), among other examples. This enables the UE 120 that is camping on the NES cell 510 to detect and receive the low-periodicity or infrequent system information communications.

In some aspects, the NES cell 510 may transmit the low-periodicity or infrequent system information communications based on, in response to, or otherwise associated with receiving the request from the UE 120 (e.g., as described in connection with reference number 635). For example, the request (e.g., the uplink wakeup signal) from the UE 120 may trigger the NES cell 510 to begin transmitting the low-periodicity or infrequent system information communications. For example, the low-periodicity or infrequent system information communications may be triggered via an uplink wakeup signal transmitted by the UE 120 (e.g., that has selected the NES cell 510 for camping).

In some aspects, the UE 120 may receive (e.g., from the NES cell 510 or from the anchor cell 505) an indication of a change in the low-periodicity or infrequent system information communications. For example, the UE 120 may receive an indication of a change in the one or more configuration parameters for the low-periodicity or infrequent system information (e.g., SIB1) communications.

In some aspects, to support camping, the NES cell 510 may periodically transmit system information (e.g., SIB1) after receiving the request from the UE 120 (e.g., as described in connection with reference number 635). For example, in addition to transmitting the on-demand system information communication, the NES cell 510 may periodically transmit system information (e.g., SIB1) after receiving the request from the UE 120. This may enable the UE 120 to camp on the NES cell 510. The periodic system information (e.g., SIB1) communications may have a short periodicity, such as from 20 to 160 milliseconds.

In some other aspects, the NES cell 510 may not support camping. In such examples, the NES cell 510 may only support direct access while operating in the NES mode. The UE 120 may receive an indication that the NES cell 510 does not support camping, such as from the anchor cell 505 or from the NES cell 510. In such examples, the UE 120 may refrain from selecting the NES cell 510 for camping (e.g., based on, in response to, or otherwise associated with receiving the indication that the NES cell 510 does not support camping). In such examples, the NES cell 510 may initiate monitoring of RACH occasions based on, in response to, or otherwise associated with, receiving the request from the UE 120 (e.g., as described in connection with reference number 635). For example, RACH monitoring by the NES cell may be triggered by an uplink wakeup signal transmitted by the UE 120. In such examples, the NES cell 510 may monitor RACH occasions for one or more cycles or periods (e.g., of an I-DRX cycle). This may enable direct access to the NES cell 510 without the NES cell 510 transmitting paging communications, resulting in increased opportunities for NES (e.g., because the NES cell 510 does not use power or energy to transmit paging communications).

In some aspects, as shown by reference number 655, the UE 120 may receive updated system information (e.g., an updated SIB1) for the NES cell 510. In some aspects, the NES cell 510 may transmit a system information update indication. For example, the UE 120 may receive, from the NES cell 510, a system information update indication. The NES cell 510 may broadcast the updated system information for one or more periods or cycles (e.g., of the I-DRX cycle). For example, the UE 120 may receive, from the NES cell 510 and in association with receiving the system information update indication, updated RMSI via a broadcast communication transmitted for one or more transmission periods or transmission cycles.

As another example, the NES cell 510 may transmit a system information update indication. For example, the UE 120 may receive, from the NES cell 510, a system information update indication. The UE 120 (e.g., that is camping on the NES cell 510) may determine that the updated system information should be obtained by the UE 120. The UE 120 may transmit, to the NES cell 510 and in association with receiving the system information update indication, a request for updated system information. The UE 120 may receive, from the NES cell 510, updated RMSI in response to transmitting the request. In other words, if the NES cell 510 has updated system information, then the NES cell 510 may transmit a system information update indication and transmit the updated system information only if a UE requests the updated system information. For example, a UE camping on the NES cell may need to transmit a new request (e.g., a new uplink wakeup signal) after receiving the system information update indication in order to receive the updated system information.

As another example, the UE 120 may transmit, to the NES cell 510 and in association with camping on the first cell for a period of time, a request for updated system information. The UE 120 may receive, from the NES cell 510, updated RMSI in response to transmitting the request. For example, the UE 120 may request updated system information after some period of time to ensure that the UE 120 has the latest or most up-to-date system information of the NES cell 510 (e.g., because the NES cell 510 may not periodically or regularly transmit the system information). There may be a limitation on how often the UE 120 can request the system information of the NES cell 510 (e.g., to reduce a likelihood that the NES cell 510 is frequently transmitting system information in response to requests from camped UEs). For example, the UE 120 transmitting the request may be based on, in response to, or otherwise associated with one or more timing conditions associated with a previous request for updated system information being met. For example, the UE 120 may be allowed to transmit requests for system information of the NES cell 510 every T seconds or every M cycles (e.g., where a cycle may be a baseline transmit periodicity (such as 160 milliseconds), an I-DRX cycle, a SIB1 period, or another cycle).

In some aspects, the UE 120 may transmit, to the NES cell 510, one or more requests for updated system information without receiving the updated system information. In such examples, the UE 120 may camp on a second cell (e.g., the anchor cell 505) based on, in response to, or otherwise associated with a quantity of the one or more requests satisfying a threshold. For example, a fallback mechanism may be supported if the UE 120 is unable to obtain updated system information for the NES cell 510. If the UE 120 transmits multiple (e.g., K) requests without receiving or acquiring the system information of the NES cell 510, then the UE 120 may select another cell for camping. In such examples, the UE 120 may not attempt to select or camp on the NES cell for a period of time, such as T seconds.

In some aspects, there may be a change to the configuration of the one or more resources used by the UE 120 to transmit requests for system information of NES cells. For example, there may be a change in the uplink wakeup signal configuration for the UE 120. As described elsewhere herein, the configuration may be transmitted by the anchor cell 505. However, the UE 120 may now be camping on the NES cell 510 and may not be monitoring a control channel or broadcast channel of the anchor cell 505. Therefore, the NES cell 510 may support indicating the update configuration to the UE 120. For example, the NES cell 510 may transmit, and the UE 120 may receive, an indication of the configuration (e.g., an uplink wakeup signal configuration). The configuration may be included in the SIB1 or another SIB.

In some aspects, the NES cell 510 may transmit an indication of the configuration only if there is a change or update in the configuration. For example, the anchor cell 505 may transmit, and the NES cell 510 may receive, an indication of the change or update in the configuration (e.g., via a backhaul or midhaul communication). The NES cell 510 may transmit the change or update in the configuration to the UE 120 based on, in response to, or otherwise associated with detecting or receiving the indication of the change or update in the configuration. In such examples, the change or update in the configuration may be included in a PDSCH (e.g., in a payload of a PDSCH communication) that is associated with a grant that is provided by a broadcast PDCCH or a group-common PDCCH (such as a paging PDCCH). As another example, the change or update in the configuration may be included in a payload of a paging PDSCH communication.

As another example, the NES cell 510 may transmit, and the UE 120 may receive, an indication that there is an update to the configuration. The indication may direct the UE 120 to acquire the update to the configuration from the anchor cell 505. The indication that there is an update to the configuration (e.g., to the uplink wakeup signal configuration) may be included in a system information update indication. The indication that there is an update to the configuration may include identifiers of one or more anchor cells (e.g., the anchor cell 505) from which the UE 120 can obtain the update.

As indicated above, FIG. 6 is provided as an example. Other examples may differ from what is described with respect to FIG. 6.

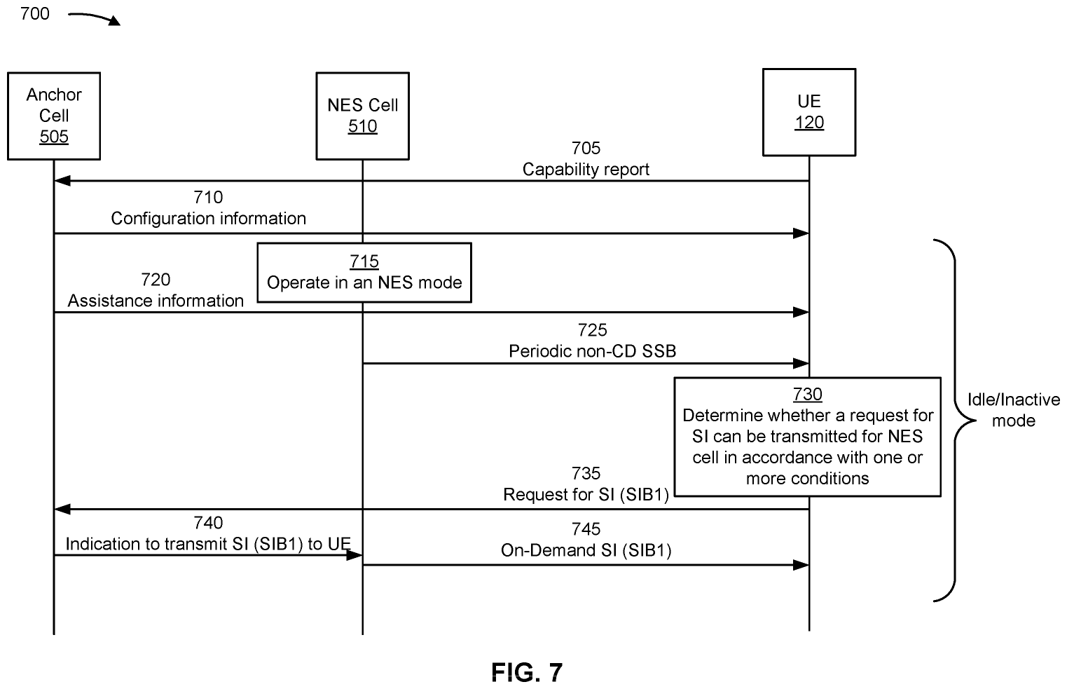

FIG. 7 is a diagram of an example 700 associated with a system information operation for network energy saving in accordance with the present disclosure. As shown in FIG. 7, the anchor cell 505 (e.g., a network node 110, a CU, a DU, and/or an RU) and/or the NES cell 510 (e.g., a network node 110, a CU, a DU, and/or an RU) may communicate with the UE 120. In some aspects, the anchor cell 505, the NES cell 510, and the UE 120 may be part of a wireless network (e.g., wireless network 100). The UE 120 and the anchor cell 505 may have established a wireless connection prior to operations shown in FIG. 7. In some aspects, the UE 120 may not have an active or connected RRC connection. For example, the UE 120 may be operating in an idle mode (e.g., an RRC idle mode or state) or an inactive mode (e.g., an RRC inactive mode or state), as shown in FIG. 7.

In some aspects, as shown by reference number 705, the UE 120 may transmit, and the anchor cell 505 (and/or the NES cell 510) may receive, a capability report. The UE 120 may transmit the capability report via an uplink communication, a UAI communication, an UCI communication, an uplink MAC-CE communication, an RRC communication, a PUCCH, and/or a PUSCH, among other examples. The capability report may indicate one or more parameters associated with respective capabilities of the UE 120. The one or more parameters may be indicated via respective IEs included in the capability report.

The capability report may indicate whether the UE 120 supports a feature and/or one or more parameters related to the feature. For example, the capability report May indicate a capability and/or parameter for selecting a cell (e.g., for camping and/or establishing a communication connection) operating in an NES mode (e.g., the NES cell 510) in accordance with one or more conditions. For example, the capability report may indicate whether the UE 120 supports camping on NES cells. As another example, the capability report may indicate a capability and/or parameter for transmitting a request for system information of the NES cell 510 (e.g., via an uplink wakeup signal or another uplink communication). One or more operations described herein may be based on capability information of the capability report. For example, the UE 120 may perform a communication in accordance with the capability information, or may receive configuration information that is in accordance with the capability information.

As shown by reference number 710, the anchor cell 505 (or the NES cell 510) may transmit, and the UE 120 may receive, configuration information. In some aspects, the UE 120 may receive the configuration information via one or more of system information (e.g., a MIB and/or a SIB, among other examples), RRC signaling, MAC signaling (e.g., one or more MAC-CEs), and/or DCI, among other examples. In some aspects, the UE 120 may receive the configuration information while operating in a connected mode (e.g., via dedicated signaling, such as RRC signaling). In other aspects, the UE 120 may receive the configuration information while operating in the idle mode or the inactive mode (e.g., via broadcast signaling, system information signaling, or other signaling).

In some aspects, the configuration information may indicate one or more candidate configurations and/or communication parameters. In some aspects, the one or more candidate configurations and/or communication parameters may be selected, activated, and/or deactivated by a subsequent indication. For example, the subsequent indication may select a candidate configuration and/or communication parameter from the one or more candidate configurations and/or communication parameters. In some aspects, the subsequent indication (e.g., an indication described herein) may include a dynamic indication, such as one or more MAC-CEs and/or one or more DCI messages, among other examples.

In some aspects, the configuration information may indicate that the UE 120 is to select NES cells (e.g., the NES cell 510) for establishing a connection (e.g., an RRC connection) or for camping in accordance with one or more conditions, as described in more detail elsewhere herein. In some aspects, the configuration information May indicate the one or more conditions. Additionally, or alternatively, the one or more conditions may be stored by the UE 120 (e.g., via an OEM configuration), such as when the one or more conditions are defined, or otherwise fixed, by a wireless communication standard (such as the 3GPP). In some aspects, the configuration information may indicate that the UE 120 is to transmit requests for system information (e.g., SIB1) of NES cells to the anchor cell 505.

The UE 120 may configure itself based at least in part on the configuration information. In some aspects, the UE 120 may be configured to perform one or more operations described herein based at least in part on the configuration information.

In some aspects, the configuration information described in connection with reference number 710 and/or the capability report described in connection with reference number 705 may include information transmitted via multiple communications. Additionally, or alternatively, the anchor cell 505 (or the NES cell 510) may transmit the configuration information, or a communication including at least a portion of the configuration information, before and/or after the UE 120 transmits the capability report. For example, the anchor cell 505 (or the NES cell 510) may transmit a first portion of the configuration information before the UE 120 transmits the capability report, the UE 120 may transmit at least a portion of the capability report, and the anchor cell 505 (or the NES cell 510) may transmit a second portion of the configuration information after receiving the capability report.

As shown by reference number 715, the NES cell 510 may operate in an NES mode. For example, the NES cell 510 may transmit one or more types of broadcast communications (e.g., SSBs and/or SIB1) in an on-demand manner. For example, when the NES cell 510 is not operating in the NES mode, the NES cell 510 may transmit the one or more types of broadcast communications periodically. However, to conserve power or energy resources, the NES cell 510 may transmit the one or more types of broadcast communications (e.g., SSBs and/or SIB1) in an on-demand manner and/or less frequently (e.g., as compared to when the NES cell 510 is not operating in the NES mode) when operating in the NES mode. In some aspects, the NES cell 510 may be configured to dynamically switch between operating in the NES mode and not operating in the NES mode, such as based on or otherwise associated with a network load for the NES cell 510. In other aspects, the NES cell 510 may always operate in the NES mode.

In some aspects, the UE 120 may receive an indication that the NES cell 510 transmits SIB1 in an on-demand manner (e.g., via the NES cell 510 or via the anchor cell 505). The indication that the NES cell 510 transmits SIB1 in an on-demand manner may be included in an indication that there is no CD-SSB for the NES cell 510. The UE 120 may discover an anchor cell (e.g., the anchor cell 505) from which the UE can acquire a configuration for requesting the SIB1 of the NES cell 510. In such examples, the anchor cell 505 may transmit an RMSI PDCCH configuration for the NES cell 510. As another example, a MIB of the NES cell 510 may indicate the RMSI PDCCH configuration for the NES cell 510 and indicate that RMSI transmissions (e.g., SIB1 transmissions) are on-demand. For example, a given value of a parameter for a gap between Subcarrier 0 of synchronization signal (SS)/PBCH block and a common resource block (e.g., a k_SSB parameter) in the MIB of the NES cell 510 may be used to indicate that RMSI transmissions (e.g., SIB1 transmissions) are on-demand for the NES cell 510.

In some aspects, the UE 120 may be connected to the NES cell 510 prior to the NES cell operating in the NES mode. For example, the UE 120 may be connected to the NES cell 510 while the NES cell is operating in an active mode or a non-NES mode. The UE 120 may transition to the idle or inactive state. Prior to releasing or suspending an RRC connection with the UE 120, the NES cell 510 may transmit, and the UE 120 may receive, assistance information associated with accessing the network if the NES cell switches to operating in the NES mode (e.g., if the cell adopts an NES feature). The assistance information may include a configuration for one or more resources available for the UE 120 to use to transmit requests for system information (e.g., RMSI or SIB1) of NES cells, such as an uplink wakeup signal configuration (e.g., as described in more detail elsewhere herein). The assistance information may include one or more frequencies and/or identifiers of other cells (such as the anchor cell 505) that are configured to assist the UE 120 with access (such as cells configured to provide a copy of system information for the NES cell 510 or providing other assistance or system information as described herein). The assistance information may include NES mode information, such as a schedule (e.g., a start time, an end time, and/or a duration) of the NES cell 510 operating in the NES mode.

The UE 120 may receive a resource configuration for one or more resources (e.g., time domain resources, frequency domain resources, and/or spatial domain resources) available for the UE 120 to use to transmit requests for system information (e.g., RMSI or SIB1) of NES cells, such as the NES cell 510. The UE 120 may receive the resource configuration from the anchor cell 505 (e.g., via assistance information), from the NES cell 510, and/or from a combination of signaling from the anchor cell 505 and the NES cell 510.

For example, as shown by reference number 720, the anchor cell 505 may transmit, and the UE 120 may receive, assistance information. The assistance information may indicate one or more resources and/or configuration information for one or more resources available for the UE 120 to transmit requests (or demands) for system information (e.g., RMSI or SIB1) of NES cells, such as the NES cell 510. The resources may be uplink resources. In some aspects, the resources may be uplink wakeup signal resources. For example, the assistance information may include an uplink wakeup signal configuration.

The assistance information may include partial system information for the NES cell 510. For example, the partial system information may include a public land mobile network (PLMN) identifier of the NES cell 510 and/or access information of the NES cell 510, among other examples. The UE 120 may use the partial system information for measuring the NES cell 510 and/or for selection of the NES cell 510, as described in more detail elsewhere herein. Other system information (e.g., a RACH configuration or other RMSI) of the NES cell 510 may be provided in an on-demand manner, as described in more detail elsewhere herein.

In some aspects, as shown by reference number 725, the NES cell 510 (when operating in the NES mode) may transmit one or more periodic communications, such as an NCD SSB. The NES cell 510 may periodically transmit one or more NCD-SSBs while operating in the NES mode (e.g., because the NCD-SSBs use less energy to transmit than CD-SSBs and/or SIB1).

In some aspects, the NES cell 510 may transmit via a broadcast channel (e.g., a PBCH). The PBCH (e.g., a payload of the PBCH) of the NES cell 510 may include information to enable UEs to acquire system information (e.g., SIB1) of the NES cell 510. For example, the PBCH (e.g., a payload of the PBCH) of the NES cell 510 may indicate one or more frequency resources (e.g., a raster) of anchor cells (e.g., the anchor cell 505) via which the UE(s) can obtain or request SIB1 of the NES cell 510. In some aspects, the PBCH (e.g., a payload of the PBCH) of the NES cell 510 may indicate identifiers of one or more anchor cells (e.g., the anchor cell 505) via which the UE(s) can obtain or request SIB1 of the NES cell 510. For example, one or more MSBs or one or more LSBs of the identifiers may be indicated via the PBCH of the NES cell 510. In some aspects, the PBCH (e.g., a payload of the PBCH) of the NES cell 510 may indicate an area identifier of the NES cell 510 and/or of the anchor cell(s).

In some aspects, the PBCH (e.g., a payload of the PBCH) of the NES cell 510 may indicate information for acquiring the SIB1 of the NES cell 510 via the anchor cell 505. For example, the PBCH of the NES cell 510 may indicate whether the anchor cell 505 broadcasts the SIB1 of the NES cell 510. If the anchor cell 505 broadcasts the SIB1 of the NES cell 510, then the PBCH of the NES cell 510 may indicate a PDCCH configuration for the system information broadcast by the anchor cell 505. In some aspects, the PBCH (e.g., a payload of the PBCH) of the NES cell 510 may indicate a PDCCH configuration of a SIB1 of the anchor cell 505 (e.g., where the SIB1 of the anchor cell 505 includes a configuration for acquiring the SIB1 of the NES cell 510). In some aspects, the PBCH (e.g., a payload of the PBCH) of the NES cell 510 may indicate whether the anchor cell 505 transmits the SIB1 of the NES cell 510 in an on-demand manner. If the anchor cell 505 transmits the SIB1 of the NES cell 510 in an on-demand manner, then the PBCH of the NES cell 510 may indicate one or more resources and/or a configuration of the one or more resources available for the UE 120 to transmit a request for the SIB1 to the anchor cell 505 (e.g., the PBCH of the NES cell 510 may indicate an uplink wakeup signal configuration for resources the UE 120 may use to transmit a request to the anchor cell 505 for the SIB1 of the NES cell 510).

As shown by reference number 730, the UE 120 may determine whether a request (or demand) for system information can be transmitted (e.g., to the anchor cell 505) in accordance with one or more conditions. For example, the UE 120 may select the NES cell 510 for obtaining system information in accordance with the one or more conditions. The one or more conditions may be similar to (or the same as) the conditions described in connection with FIG. 5 and/or reference number 550. For example, the conditions may be associated with defining scenarios in which the UE 120 is allowed to transmit a request for the system information for the NES cell (e.g., is allowed to transmit an uplink wakeup signal to, or for, the NES cell 510). As a result, the UE 120 may only transmit the request if the one or more conditions are met or satisfied. This may reduce the quantity of on-demand communications (e.g., on-demand SIB1s) transmitted by the NES cell 510 while operating in the NES mode. The reduced quantity of on-demand communications may conserve power and/or energy of the NES cell 510 and/or improve the effectiveness or efficiency of the NES mode.

As shown by reference number 735, the UE 120 may transmit, and the anchor cell 505 may receive, a request for system information (e.g., RMSI or a SIB1) of the NES cell 510. For example, the UE 120 may transmit the request using a resource that is configured for the UE 120 and/or that is monitored by the anchor cell 505. The request may be included in an uplink communication, such as an uplink wakeup signal or another uplink communication. The UE 120 may transmit the request based on, in response to, or otherwise associated with the one or more conditions being met or satisfied, as described in more detail elsewhere herein.

In some aspects, the request for the system information may indicate spatial domain information. For example, the request may indicate a beam (or beam group) indication. For example, a RACH occasion or physical RACH (PRACH) preamble selection can be a function of the identifier of the NES cell 510 and a detected beam of the NES cell 510.

In some aspects, the anchor cell 505 may transmit, and the UE 120 may receive, an acknowledgement communication associated with the request. For example, the acknowledgement communication may indicate whether the NES cell 510 (and may identify the NES cell 510) will transmit an on-demand system information communication (e.g., an on-demand SIB1). For example, the acknowledgement communication may indicate whether the NES cell 510 (and which cell) will activate SIB1.

In some examples, the UE 120 may refrain from camping on the NES cell 510 and instead may only directly access the NES cell 510 (e.g., for establishing a communication connection). In other examples, multiple mechanisms for SIB requests of the NES cell 510 may be supported. For example, the UE 120 may support or be configured to request system information (e.g., SIB1) of the NES cell via a request transmitted directly to the NES cell 510 (e.g., in a similar manner as described in connection with FIG. 6) or via a request transmitted to the anchor cell 505. In such examples, the UE 120 may support camping on the NES cell 510, in a similar manner as described elsewhere herein.

As shown by reference number 740, the anchor cell 505 and the NES cell 510 may perform backhaul coordination to trigger the on-demand system information (e.g., the on-demand SIB1) communication by the NES cell 510 (e.g., based on, in response to, or otherwise associated with the request from the UE 120). If the anchor cell 505 and the NES cell 510 are associated with (e.g., belong to or are controlled by) the same DU, then the backhaul coordination may include a gNB-DU configuration update (e.g., updated MIB information carried in gNB-DU system information).

However, in some examples, the anchor cell 505 and the NES cell 510 may be associated with (e.g., belong to or be controlled by) different DUs and/or different CUs. For example, the anchor cell 505 may be associated with a first DU and a first CU. The NES cell 510 may be associated with a second DU (and the first CU or a second CU). In such examples, the backhaul coordination may include the first DU transmitting, and the first CU receiving, a request (e.g., in a backhaul communication) for the NES cell 510 to transmit an on-demand system information (e.g., and on-demand SIB1) communication. The first CU may transmit, and the second DU may receive, the request (e.g., in a backhaul communication) for the NES cell 510 to transmit an on-demand system information (e.g., and on-demand SIB1) communication. In examples where the anchor cell 505 and the NES cell 510 are associated with different CUs, the first CU may transmit, and the second CU may receive, a request (e.g., in a backhaul communication) for the NES cell 510 to transmit an on-demand system information (e.g., and on-demand SIB1) communication. The second CU may transmit, and the second DU may receive, the request (e.g., in a backhaul communication) for the NES cell 510 to transmit an on-demand system information (e.g., and on-demand SIB1) communication. The backhaul communication may be part of, or included in, a cell activation request procedure.

The requests (e.g., transmitted as part of the backhaul coordination) may include one or more request parameters. The one or more request parameters may include spatial domain information. The spatial domain information may include an indication of one or more beams, one or more beam groups, and/or one or more geographic areas or zones, among other examples, in which the on-demand system information (e.g., on-demand SIB1) is to be transmitted. For example, the request for SIB1 may indicate one or more SSB(s) received/detected from the NES cell 510 (e.g., an index of the one or more SSBs). The one or more request parameters may include timing information, such as an indication of a duration (e.g., a quantity of cycles) of on-demand communications and/or a starting time of the on-demand communications, among other examples.

In some aspects, the one or more request parameters may include an indication of a cause of the request and/or a reason for a rejection of a request. For example, the cause of the request may include the reception of a direct request from one or more UEs, another cell (e.g., the anchor cell 505) being overloaded, and/or another cell (e.g., the anchor cell 505) transitioning into the NES mode, among other examples. A cause for a rejection of a request may include that the NES cell 510 does not currently support SIB1 activation or that SIB transmissions have already been activated for the NES cell 510, among other examples.

In some aspects, the backhaul coordination may include an exchange (e.g., across one or more backhaul interfaces or network interfaces) that the NES cell 510 is not transmitting SIB1, but supports activating SIB1 transmission (e.g., supports transmitting SIB1 in an on-demand manner). For example, the backhaul coordination may support information exchange across network interfaces to indicate that an NES cell may not be transmitting SIB1, but supports activating SIB transmission.

As shown by reference number 745, the NES cell 510 may transmit, and the UE 120 may receive, an on-demand system information communication, such as an on-demand SIB1. The NES cell 510 may transmit the on-demand system information communication based on, in response to, or otherwise associated with receiving the request from the anchor cell 505 (or another network node). In other words, the backhaul coordination described herein may trigger the NES cell 510 to transmit the on-demand system information communication for the UE 120 (or another UE 120). For example, the NES cell 510 may activate a transmission of the SIB1 based on, in response to, or otherwise associated with the backhaul coordination.

As indicated above, FIG. 7 is provided as an example. Other examples may differ from what is described with respect to FIG. 7.

FIG. 8 is a diagram illustrating an example process 800 performed, for example, at a UE or an apparatus of a UE, in accordance with the present disclosure. Example process 800 is an example where the apparatus or the UE (e.g., UE 120) performs operations associated with system information operation for network energy saving.

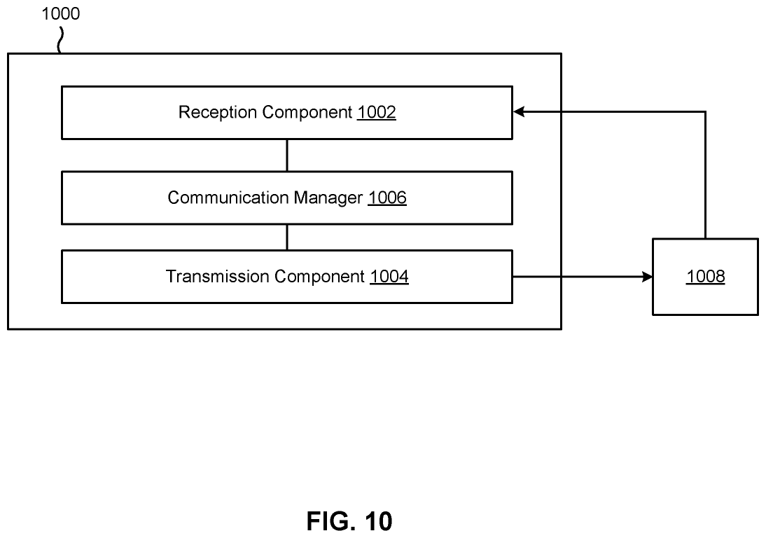

As shown in FIG. 8, in some aspects, process 800 may include receiving a communication including RMSI for a first cell that is operating in an NES mode (block 810). For example, the UE (e.g., using reception component 1002 and/or communication manager 1006, depicted in FIG. 10) may receive a communication including RMSI for a first cell that is operating in an NES mode, as described above.

As further shown in FIG. 8, in some aspects, process 800 may include performing an operation associated with a selection of the first cell, the selection of the first cell being in accordance with one or more conditions being met (block 820). For example, the UE (e.g., using communication manager 1006, depicted in FIG. 10) may perform an operation associated with a selection of the first cell, the selection of the first cell being in accordance with one or more conditions being met, as described above.

Process 800 may include additional aspects, such as any single aspect or any combination of aspects described below and/or in connection with one or more other processes described elsewhere herein.

In a first aspect, the operation includes selecting the first cell for establishing a connection, wherein receiving the communication includes receiving, from a second cell, the communication, wherein the one or more conditions being met includes the UE being associated with an authorized subscription for accessing the first cell.

In a second aspect, alone or in combination with the first aspect, the operation includes selecting the first cell for establishing a connection, wherein receiving the communication includes receiving, from a second cell, the communication, and receiving, from the second cell, an indication that the UE is authorized to access the first cell, wherein the one or more conditions being met includes the UE receiving the indication that the UE is authorized to access the first cell.

In a third aspect, alone or in combination with one or more of the first and second aspects, process 800 includes receiving, from a second cell, a paging communication, wherein the one or more conditions being met includes the UE receiving the paging communication.

In a fourth aspect, alone or in combination with one or more of the first through third aspects, the operation includes a RACH operation that is performable in association with the UE receiving the paging communication.

In a fifth aspect, alone or in combination with one or more of the first through fourth aspects, the paging communication indicates that the UE is authorized to access the first cell, and the one or more conditions being met includes the paging communication indicating that the UE is authorized to access the first cell.

In a sixth aspect, alone or in combination with one or more of the first through fifth aspects, the operation is associated with the UE having uplink traffic to transmit, and the one or more conditions are associated with the uplink traffic having at least one of an allowable traffic type, an allowable quality of service class, or an allowable purpose.

In a seventh aspect, alone or in combination with one or more of the first through sixth aspects, process 800 includes transmitting, to the first cell, a request for the communication, the transmission of the request being associated with the one or more conditions being met, wherein receiving the communication is in response to transmitting the request.

In an eighth aspect, alone or in combination with one or more of the first through seventh aspects, the operation includes camping on the first cell.

In a ninth aspect, alone or in combination with one or more of the first through eighth aspects, receiving the communication includes receiving, from the first cell, one or more system information communications including the RMSI, the one or more system information communications being received during one or more periods prior to a paging occasion for an idle discontinuous reception cycle that is configured for the UE.

In a tenth aspect, alone or in combination with one or more of the first through ninth aspects, process 800 includes receiving configuration information for the one or more periods.

In an eleventh aspect, alone or in combination with one or more of the first through tenth aspects, process 800 includes transmitting, to the first cell, a request for system information of the first cell, wherein receiving the one or more system information communications is in response to transmitting the request.

In a twelfth aspect, alone or in combination with one or more of the first through eleventh aspects, process 800 includes receiving, from the first cell or second cell, updated configuration information for the one or more system information communications.

In a thirteenth aspect, alone or in combination with one or more of the first through twelfth aspects, process 800 includes receiving, from the first cell, a system information update indication, and receiving, from the first cell and in association with receiving the system information update indication, updated RMSI via a broadcast communication transmitted for one or more transmission periods or transmission cycles.

In a fourteenth aspect, alone or in combination with one or more of the first through thirteenth aspects, process 800 includes receiving, from the first cell, a system information update indication, transmitting, to the first cell and in association with receiving the system information update indication, a request for updated system information, and receiving, from the first cell, updated RMSI in response to transmitting the request.

In a fifteenth aspect, alone or in combination with one or more of the first through fourteenth aspects, process 800 includes transmitting, to the first cell and in association with camping on the first cell for a period of time, a request for updated system information, and receiving, from the first cell, updated RMSI in response to transmitting the request.

In a sixteenth aspect, alone or in combination with one or more of the first through fifteenth aspects, transmitting the request is associated with one or more timing conditions associated with a previous request for updated system information being met.

In a seventeenth aspect, alone or in combination with one or more of the first through sixteenth aspects, process 800 includes transmitting, to the first cell, one or more requests for updated system information without receiving the updated system information, and camping on a second cell in association with a quantity of the one or more requests satisfying a threshold.

In an eighteenth aspect, alone or in combination with one or more of the first through seventeenth aspects, process 800 includes receiving an indication that the UE is not allowed to camp on the first cell, and monitoring a second cell in association with camping on the second cell, wherein the operation includes establishing a communication connection with the first cell.

In a nineteenth aspect, alone or in combination with one or more of the first through eighteenth aspects, process 800 includes receiving, from a second cell, configuration information for one or more resources associated with requests for system information, transmitting, to the second cell, a request for system information using at least one of the one or more resources, wherein receiving the communication is in response to transmitting the request, and receiving, from the first cell, an indication of updated configuration information for the one or more resources.

In a twentieth aspect, alone or in combination with one or more of the first through nineteenth aspects, the indication of the updated configuration information is included in the communication or in another system information communication.

In a twenty-first aspect, alone or in combination with one or more of the first through twentieth aspects, the indication of the updated configuration information indicates that the updated configuration information is available via the second cell, and process 800 includes receiving, from the second cell and in association with receiving the indication of the updated configuration information, the updated configuration information.

In a twenty-second aspect, alone or in combination with one or more of the first through twenty-first aspects, the UE is operating in a connected mode with a connection to the first cell prior to receiving the communication, and process 800 includes receiving, from the first cell and while operating in the connected mode, assistance information for accessing the first cell when the first cell is operating in the NES mode.

In a twenty-third aspect, alone or in combination with one or more of the first through twenty-second aspects, the assistance information includes at least one of: information for one or more resources associated with requests for system information, the one or more conditions, or the RMSI.

In a twenty-fourth aspect, alone or in combination with one or more of the first through twenty-third aspects, process 800 includes transmitting, to a second cell, a request for system information for the first cell, wherein transmitting the request is in association with the one or more conditions being met, and wherein receiving the communication includes receiving, from the first cell, the communication in response to transmitting the request.

In a twenty-fifth aspect, alone or in combination with one or more of the first through twenty-fourth aspects, process 800 includes receiving, from a second cell and prior to receiving the communication, partial system information for the first cell.

In a twenty-sixth aspect, alone or in combination with one or more of the first through twenty-fifth aspects, the partial system information includes at least one of a public land mobile network identifier, or celling access information.

In a twenty-seventh aspect, alone or in combination with one or more of the first through twenty-sixth aspects, process 800 includes transmitting, to a second cell, a request for system information for the first cell, the request including an indication of spatial domain information associated with the UE and the first cell, and receiving the communication includes receiving, from the first cell, the communication in response to transmitting the request.

In a twenty-eighth aspect, alone or in combination with one or more of the first through twenty-seventh aspects, process 800 includes receiving an SSB via the first cell prior to receiving the communication, wherein the spatial domain information includes an index of the SSB.

In a twenty-ninth aspect, alone or in combination with one or more of the first through twenty-eighth aspects, process 800 includes receiving an acknowledgement communication associated with the request indicating whether the first cell is to transmit the communication.

In a thirtieth aspect, alone or in combination with one or more of the first through twenty-ninth aspects, process 800 includes receiving, from the first cell, a broadcast channel communication indicating assistance information for obtaining the RMSI via a second cell.

In a thirty-first aspect, alone or in combination with one or more of the first through thirtieth aspects, the assistance information includes at least one of: resources via which the second cell is to transmit the communication, a cell identifier of the second cell, an area identifier of the second cell, or information for receiving the communication via the second cell.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, at a network node or an apparatus of a network node, in accordance with the present disclosure. Example process 900 is an example where the apparatus or the network node (e.g., network node 110, the anchor cell 505, and/or the NES cell 510) performs operations associated with system information operation for network energy saving.

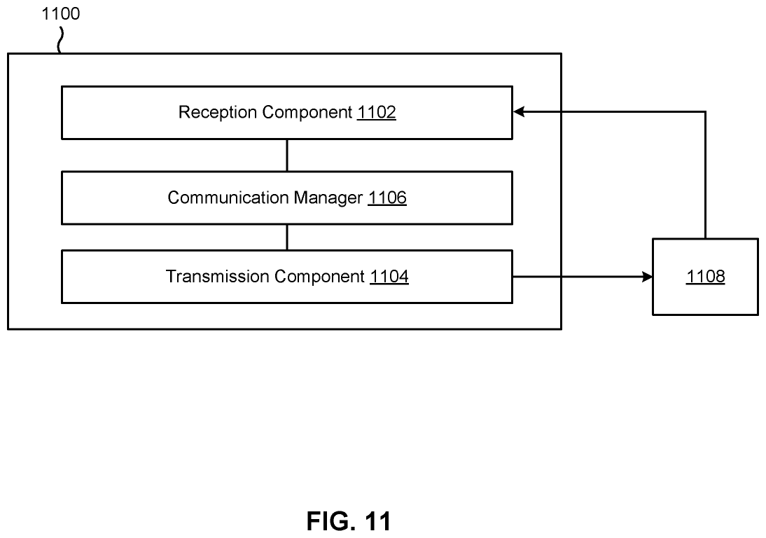

As shown in FIG. 9, in some aspects, process 900 may include receiving, for a UE, a request for system information for a first cell that is operating in an NES mode (block 910). For example, the network node (e.g., using reception component 1102 and/or communication manager 1106, depicted in FIG. 11) may receive, for a UE, a request for system information for a first cell that is operating in an NES mode, as described above.

As further shown in FIG. 9, in some aspects, process 900 may include transmitting a communication including RMSI for the first cell in accordance with one or more conditions being met (block 920). For example, the network node (e.g., using transmission component 1104 and/or communication manager 1106, depicted in FIG. 11) may transmit a communication including RMSI for the first cell in accordance with one or more conditions being met, as described above.

Process 900 may include additional aspects, such as any single aspect or any combination of aspects described below and/or in connection with one or more other processes described elsewhere herein.

In a first aspect, the one or more conditions being met includes the UE being associated with an authorized subscription for accessing the first cell.

In a second aspect, alone or in combination with the first aspect, transmitting the communication includes transmitting, via a second cell, the communication, and transmitting, from the second cell, an indication that the UE is authorized to access the first cell, wherein the one or more conditions being met includes transmitting the indication that the UE is authorized to access the first cell.

In a third aspect, alone or in combination with one or more of the first and second aspects, process 900 includes transmitting, via a second cell, a paging communication, wherein the one or more conditions being met includes transmitting the paging communication.

In a fourth aspect, alone or in combination with one or more of the first through third aspects, process 900 includes monitoring, via the second cell, one or more random access channel resources associated with the UE in association with transmitting the paging communication for the UE.

In a fifth aspect, alone or in combination with one or more of the first through fourth aspects, the paging communication indicates that the UE is authorized to access the first cell, and the one or more conditions being met includes the paging communication indicating that the UE is authorized to access the first cell.

In a sixth aspect, alone or in combination with one or more of the first through fifth aspects, process 900 includes transmitting an indication that the UE is not allowed to camp on the first cell.

In a seventh aspect, alone or in combination with one or more of the first through sixth aspects, process 900 includes transmitting, via a second cell, configuration information for one or more resources associated with requests for system information, and transmitting, via the first cell, an indication of updated configuration information for the one or more resources.

In an eighth aspect, alone or in combination with one or more of the first through seventh aspects, the indication of the updated configuration information is included in the communication or in another system information communication.

In a ninth aspect, alone or in combination with one or more of the first through eighth aspects, the indication of the updated configuration information indicates that the updated configuration information is available via the second cell, and process 900 includes transmitting, via the second cell and in association with receiving the indication of the updated configuration information, the updated configuration information.

In a tenth aspect, alone or in combination with one or more of the first through ninth aspects, the UE is in a connected mode with a connection to the first cell prior to receiving the communication, and process 900 includes transmitting, via the first cell and while the UE is in the connected mode, assistance information for accessing the first cell when the first cell is operating in the NES mode.

In an eleventh aspect, alone or in combination with one or more of the first through tenth aspects, the assistance information includes at least one of: information for one or more resources associated with requests for system information, the one or more conditions, or the RMSI.

In a twelfth aspect, alone or in combination with one or more of the first through eleventh aspects, process 900 includes receiving, via a second cell, a request for system information for the first cell, wherein receiving the request is in association with the one or more conditions being met.

In a thirteenth aspect, alone or in combination with one or more of the first through twelfth aspects, process 900 includes transmitting, via a second cell and prior to transmitting the communication, partial system information for the first cell.

In a fourteenth aspect, alone or in combination with one or more of the first through thirteenth aspects, the partial system information includes at least one of a public land mobile network identifier, or celling access information.

In a fifteenth aspect, alone or in combination with one or more of the first through fourteenth aspects, process 900 includes receiving, via a second cell, a request for system information for the first cell, the request including an indication of spatial domain information associated with the UE and the first cell.

In a sixteenth aspect, alone or in combination with one or more of the first through fifteenth aspects, process 900 includes transmitting, via the first cell, an SSB prior to receiving the communication, wherein the spatial domain information includes an index of the SSB.

In a seventeenth aspect, alone or in combination with one or more of the first through sixteenth aspects, process 900 includes transmitting an acknowledgement communication associated with the request indicating whether the first cell is to transmit the communication.

In an eighteenth aspect, alone or in combination with one or more of the first through seventeenth aspects, process 900 includes transmitting, via the first cell, a broadcast channel communication indicating assistance information for obtaining the RMSI via a second cell.

In a nineteenth aspect, alone or in combination with one or more of the first through eighteenth aspects, the assistance information includes at least one of: resources via which the second cell is to transmit the communication, a cell identifier of the second cell, an area identifier of the second cell, or information for receiving the communication via the second cell.

In a twentieth aspect, alone or in combination with one or more of the first through nineteenth aspects, the network node is a first network node, wherein the first network node is associated with the first cell, and receiving the request for the system information includes receiving, from a second network node, the request for system information.

In a twenty-first aspect, alone or in combination with one or more of the first through twentieth aspects, the request for system information includes at least one of spatial domain information for the communication, a timing of the communication, an indication to activate transmission of the RMSI, or an indication of a cause of the request.

In a twenty-second aspect, alone or in combination with one or more of the first through twenty-first aspects, process 900 includes transmitting, to the second network node, an indication of whether the first network node is to transmit the communication.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication, in accordance with the present disclosure. The apparatus 1000 may be a UE, or a UE may include the apparatus 1000. In some aspects, the apparatus 1000 includes a reception component 1002, a transmission component 1004, and/or a communication manager 1006, which may be in communication with one another (for example, via one or more buses and/or one or more other components). In some aspects, the communication manager 1006 is the communication manager 140 described in connection with FIG. 1. As shown, the apparatus 1000 may communicate with another apparatus 1008, such as a UE or a network node (such as a CU, a DU, an RU, or a base station), using the reception component 1002 and the transmission component 1004.

In some aspects, the apparatus 1000 may be configured to perform one or more operations described herein in connection with FIGS. 5-7. Additionally, or alternatively, the apparatus 1000 may be configured to perform one or more processes described herein, such as process 800 of FIG. 8, or a combination thereof. In some aspects, the apparatus 1000 and/or one or more components shown in FIG. 10 may include one or more components of the UE described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, one or more modems, one or more demodulators, one or more MIMO detectors, one or more receive processors, one or more controllers/processors, one or more memories, or a combination thereof, of the UE described in connection with FIG. 2.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1008. In some aspects, the transmission component 1004 may include one or more antennas, one or more modems, one or more modulators, one or more transmit MIMO processors, one or more transmit processors, one or more controllers/processors, one or more memories, or a combination thereof, of the UE described in connection with FIG. 2. In some aspects, the transmission component 1004 may be co-located with the reception component 1002 in one or more transceivers.

The communication manager 1006 may support operations of the reception component 1002 and/or the transmission component 1004. For example, the communication manager 1006 may receive information associated with configuring reception of communications by the reception component 1002 and/or transmission of communications by the transmission component 1004. Additionally, or alternatively, the communication manager 1006 may generate and/or provide control information to the reception component 1002 and/or the transmission component 1004 to control reception and/or transmission of communications.

The reception component 1002 may receive a communication including RMS) for a first cell that is operating in an NES mode. The communication manager 1006 may perform an operation associated with a selection of the first cell, the selection of the first cell being in accordance with one or more conditions being met.

The reception component 1002 may receive, from a second cell, a paging communication wherein the one or more conditions being met includes the UE receiving the paging communication.

The transmission component 1004 may transmit, to the first cell, a request for the communication, the transmission of the request being associated with the one or more conditions being met wherein receiving the communication is in response to transmitting the request.

The reception component 1002 may receive configuration information for the one or more periods.

The transmission component 1004 may transmit, to the first cell, a request for system information of the first cell wherein receiving the one or more system information communications is in response to transmitting the request.

The reception component 1002 may receive, from the first cell or second cell, updated configuration information for the one or more system information communications.

The reception component 1002 may receive, from the first cell, a system information update indication.

The reception component 1002 may receive, from the first cell and in association with receiving the system information update indication, updated RMSI via a broadcast communication transmitted for one or more transmission periods or transmission cycles.

The reception component 1002 may receive, from the first cell, a system information update indication.

The transmission component 1004 may transmit, to the first cell and in association with receiving the system information update indication, a request for updated system information.

The reception component 1002 may receive, from the first cell, updated RMSI in response to transmitting the request.

The transmission component 1004 may transmit, to the first cell and in association with camping on the first cell for a period of time, a request for updated system information.

The reception component 1002 may receive, from the first cell, updated RMSI in response to transmitting the request.

The transmission component 1004 may transmit, to the first cell, one or more requests for updated system information without receiving the updated system information.

The communication manager 1006 may camp on a second cell in association with a quantity of the one or more requests satisfying a threshold.

The reception component 1002 may receive an indication that the UE is not allowed to camp on the first cell.

The communication manager 1006 may monitor a second cell in association with camping on the second cell wherein the operation includes establishing a communication connection with the first cell.

The reception component 1002 may receive, from a second cell, configuration information for one or more resources associated with requests for system information.

The transmission component 1004 may transmit, to the second cell, a request for system information using at least one of the one or more resources wherein receiving the communication is in response to transmitting the request.

The reception component 1002 may receive, from the first cell, an indication of updated configuration information for the one or more resources.

The transmission component 1004 may transmit, to a second cell, a request for system information for the first cell, wherein transmitting the request is in association with the one or more conditions being met, and wherein receiving the communication comprises receiving, from the first cell, the communication in response to transmitting the request.

The reception component 1002 may receive, from a second cell and prior to receiving the communication, partial system information for the first cell.

The transmission component 1004 may transmit, to a second cell, a request for system information for the first cell, the request including an indication of spatial domain information associated with the UE and the first cell, and receiving the communication comprises receiving, from the first cell, the communication in response to transmitting the request.

The reception component 1002 may receive an SSB via the first cell prior to receiving the communication wherein the spatial domain information includes an index of the SSB.

The reception component 1002 may receive an acknowledgement communication associated with the request indicating whether the first cell is to transmit the communication.

The reception component 1002 may receive, from the first cell, a broadcast channel communication indicating assistance information for obtaining the RMSI via a second cell.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

FIG. 11 is a diagram of an example apparatus 1100 for wireless communication, in accordance with the present disclosure. The apparatus 1100 may be a network node, or a network node may include the apparatus 1100. In some aspects, the apparatus 1100 includes a reception component 1102, a transmission component 1104, and/or a communication manager 1106, which may be in communication with one another (for example, via one or more buses and/or one or more other components). In some aspects, the communication manager 1106 is the communication manager 150 described in connection with FIG. 1. As shown, the apparatus 1100 may communicate with another apparatus 1108, such as a UE or a network node (such as a CU, a DU, an RU, or a base station), using the reception component 1102 and the transmission component 1104.

In some aspects, the apparatus 1100 may be configured to perform one or more operations described herein in connection with FIGS. 5-7. Additionally, or alternatively, the apparatus 1100 may be configured to perform one or more processes described herein, such as process 900 of FIG. 9, or a combination thereof. In some aspects, the apparatus 1100 and/or one or more components shown in FIG. 11 may include one or more components of the network node described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, one or more modems, one or more demodulators, one or more MIMO detectors, one or more receive processors, one or more controllers/processors, one or more memories, or a combination thereof, of the network node described in connection with FIG. 2. In some aspects, the reception component 1102 and/or the transmission component 1104 may include or may be included in a network interface. The network interface may be configured to obtain and/or output signals for the apparatus 1100 via one or more communications links, such as a backhaul link, a midhaul link, and/or a fronthaul link.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1108. In some aspects, the transmission component 1104 may include one or more antennas, one or more modems, one or more modulators, one or more transmit MIMO processors, one or more transmit processors, one or more controllers/processors, one or more memories, or a combination thereof, of the network node described in connection with FIG. 2. In some aspects, the transmission component 1104 may be co-located with the reception component 1102 in one or more transceivers.

The communication manager 1106 may support operations of the reception component 1102 and/or the transmission component 1104. For example, the communication manager 1106 may receive information associated with configuring reception of communications by the reception component 1102 and/or transmission of communications by the transmission component 1104. Additionally, or alternatively, the communication manager 1106 may generate and/or provide control information to the reception component 1102 and/or the transmission component 1104 to control reception and/or transmission of communications.

The reception component 1102 may receive, for a UE, a request for system information for a first cell that is operating in an NES mode. The transmission component 1104 may transmit a communication including RMSI for the first cell in accordance with one or more conditions being met.

The transmission component 1104 may transmit, via a second cell, a paging communication wherein the one or more conditions being met includes transmitting the paging communication.

The communication manager 1106 may monitor, via the second cell, one or more random access channel resources associated with the UE in association with transmitting the paging communication for the UE.

The transmission component 1104 may transmit an indication that the UE is not allowed to camp on the first cell.

The transmission component 1104 may transmit, via a second cell, configuration information for one or more resources associated with requests for system information.

The transmission component 1104 may transmit, via the first cell, an indication of updated configuration information for the one or more resources.

The reception component 1102 may receive, via a second cell, a request for system information for the first cell, wherein receiving the request is in association with the one or more conditions being met.

The transmission component 1104 may transmit, via a second cell and prior to transmitting the communication, partial system information for the first cell.

The reception component 1102 may receive, via a second cell, a request for system information for the first cell, the request including an indication of spatial domain information associated with the UE and the first cell.

The transmission component 1104 may transmit, via the first cell, an SSB prior to receiving the communication wherein the spatial domain information includes an index of the SSB.

The transmission component 1104 may transmit an acknowledgement communication associated with the request indicating whether the first cell is to transmit the communication.

The transmission component 1104 may transmit, via the first cell, a broadcast channel communication indicating assistance information for obtaining the RMSI via a second cell.

The transmission component 1104 may transmit, to the second network node, an indication of whether the first network node is to transmit the communication.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:
Aspect 1: A method of wireless communication performed by a user equipment (UE), comprising: receiving a communication including remaining minimum system information (RMSI) for a first cell that is operating in a network energy saving (NES) mode; and performing an operation associated with a selection of the first cell, the selection of the first cell being in accordance with one or more conditions being met.
Aspect 2: The method of Aspect 1, wherein the operation includes selecting the first cell for establishing a connection, wherein receiving the communication comprises: receiving, from a second cell, the communication, wherein the one or more conditions being met includes the UE being associated with an authorized subscription for accessing the first cell.
Aspect 3: The method of any of Aspects 1-2, wherein the operation includes selecting the first cell for establishing a connection, wherein receiving the communication comprises: receiving, from a second cell, the communication; and receiving, from the second cell, an indication that the UE is authorized to access the first cell, wherein the one or more conditions being met includes the UE receiving the indication that the UE is authorized to access the first cell.
Aspect 4: The method of any of Aspects 1-3, further comprising: receiving, from a second cell, a paging communication, wherein the one or more conditions being met includes the UE receiving the paging communication.
Aspect 5: The method of Aspect 4, wherein the operation includes a random access channel (RACH) operation that is performable in association with the UE receiving the paging communication.
Aspect 6: The method of any of Aspects 4-5, wherein the paging communication indicates that the UE is authorized to access the first cell, and wherein the one or more conditions being met includes the paging communication indicating that the UE is authorized to access the first cell.
Aspect 7: The method of any of Aspects 1-6, wherein the operation is associated with the UE having uplink traffic to transmit, and wherein the one or more conditions are associated with the uplink traffic having at least one of: an allowable traffic type, an allowable quality of service class, or an allowable purpose.
Aspect 8: The method of any of Aspects 1-7, further comprising: transmitting, to the first cell, a request for the communication, the transmission of the request being associated with the one or more conditions being met, wherein receiving the communication is in response to transmitting the request.
Aspect 9: The method of any of Aspects 1-8, wherein the operation includes camping on the first cell.
Aspect 10: The method of Aspect 9, wherein receiving the communication comprises: receiving, from the first cell, one or more system information communications including the RMSI, the one or more system information communications being received during one or more periods prior to a paging occasion for an idle discontinuous reception cycle that is configured for the UE.
Aspect 11: The method of Aspect 10, further comprising: receiving configuration information for the one or more periods.
Aspect 12: The method of any of Aspects 10-11, further comprising: transmitting, to the first cell, a request for system information of the first cell, wherein receiving the one or more system information communications is in response to transmitting the request.
Aspect 13: The method of any of Aspects 10-12, further comprising: receiving, from the first cell or second cell, updated configuration information for the one or more system information communications.
Aspect 14: The method of any of Aspects 10-13, further comprising: receiving, from the first cell, a system information update indication; and receiving, from the first cell and in association with receiving the system information update indication, updated RMSI via a broadcast communication transmitted for one or more transmission periods or transmission cycles.
Aspect 15: The method of any of Aspects 10-14, further comprising: receiving, from the first cell, a system information update indication; transmitting, to the first cell and in association with receiving the system information update indication, a request for updated system information; and receiving, from the first cell, updated RMSI in response to transmitting the request.
Aspect 16: The method of any of Aspects 10-15, further comprising: transmitting, to the first cell and in association with camping on the first cell for a period of time, a request for updated system information; and receiving, from the first cell, updated RMSI in response to transmitting the request.
Aspect 17: The method of Aspect 16, wherein transmitting the request is associated with one or more timing conditions associated with a previous request for updated system information being met.
Aspect 18: The method of any of Aspects 10-17, further comprising: transmitting, to the first cell, one or more requests for updated system information without receiving the updated system information; and camping on a second cell in association with a quantity of the one or more requests satisfying a threshold.
Aspect 19: The method of any of Aspects 1-18, further comprising: receiving an indication that the UE is not allowed to camp on the first cell; and monitoring a second cell in association with camping on the second cell, wherein the operation includes establishing a communication connection with the first cell.
Aspect 20: The method of any of Aspects 1-19, further comprising: receiving, from a second cell, configuration information for one or more resources associated with requests for system information; transmitting, to the second cell, a request for system information using at least one of the one or more resources, wherein receiving the communication is in response to transmitting the request; and receiving, from the first cell, an indication of updated configuration information for the one or more resources.
Aspect 21: The method of Aspect 20, wherein the indication of the updated configuration information is included in the communication or in another system information communication.
Aspect 22: The method of any of Aspects 20-21, wherein the indication of the updated configuration information indicates that the updated configuration information is available via the second cell, the method further comprising: receiving, from the second cell and in association with receiving the indication of the updated configuration information, the updated configuration information.
Aspect 23: The method of any of Aspects 1-22, wherein the UE is operating in a connected mode with a connection to the first cell prior to receiving the communication, the method further comprising: receiving, from the first cell and while operating in the connected mode, assistance information for accessing the first cell when the first cell is operating in the NES mode.
Aspect 24: The method of Aspect 23, wherein the assistance information includes at least one of: configuration information for one or more resources associated with requests for system information, the one or more conditions, or the RMSI.
Aspect 25: The method of any of Aspects 1-24, further comprising: transmitting, to a second cell, a request for system information for the first cell, wherein transmitting the request is in association with the one or more conditions being met, and wherein receiving the communication comprises: receiving, from the first cell, the communication in response to transmitting the request.
Aspect 26: The method of any of Aspects 1-25, further comprising: receiving, from a second cell and prior to receiving the communication, partial system information for the first cell.
Aspect 27: The method of Aspect 26, wherein the partial system information includes at least one of: a public land mobile network identifier, or cell access information.
Aspect 28: The method of any of Aspects 1-27, further comprising: transmitting, to a second cell, a request for system information for the first cell, the request including an indication of spatial domain information associated with the UE and the first cell, and wherein receiving the communication comprises: receiving, from the first cell, the communication in response to transmitting the request.
Aspect 29: The method of Aspect 28, further comprising: receiving a synchronization signal block (SSB) via the first cell prior to receiving the communication, wherein the spatial domain information includes an index of the SSB.
Aspect 30: The method of any of Aspects 28-29, further comprising: receiving an acknowledgement communication associated with the request indicating whether the first cell is to transmit the communication.
Aspect 31: The method of any of Aspects 1-30, further comprising: receiving, from the first cell, a broadcast channel communication indicating assistance information for obtaining the RMSI via a second cell.
Aspect 32: The method of Aspect 31, wherein the assistance information includes at least one of: frequency resources via which the second cell is to transmit the communication, a cell identifier of the second cell, an area identifier of the second cell, or information for receiving the communication via the second cell.
Aspect 33: A method of wireless communication performed by a network node, comprising: receiving, for a user equipment (UE), a request for system information for a first cell that is operating in a network energy saving (NES) mode; and transmitting a communication including remaining minimum system information (RMSI) for the first cell in accordance with one or more conditions being met.
Aspect 34: The method of Aspect 33, wherein the one or more conditions being met includes the UE being associated with an authorized subscription for accessing the first cell.
Aspect 35: The method of any of Aspects 33-34, wherein transmitting the communication comprises: transmitting, via a second cell, the communication; and transmitting, from the second cell, an indication that the UE is authorized to access the first cell, wherein the one or more conditions being met includes transmitting the indication that the UE is authorized to access the first cell.
Aspect 36: The method of any of Aspects 33-35, further comprising: transmitting, via a second cell, a paging communication, wherein the one or more conditions being met includes transmitting the paging communication.
Aspect 37: The method of Aspect 36, further comprising: monitoring, via the second cell, one or more random access channel resources associated with the UE in association with transmitting the paging communication for the UE.
Aspect 38: The method of any of Aspects 36-37, wherein the paging communication indicates that the UE is authorized to access the first cell, and wherein the one or more conditions being met includes the paging communication indicating that the UE is authorized to access the first cell.
Aspect 39: The method of any of Aspects 33-38, further comprising: transmitting an indication that the UE is not allowed to camp on the first cell.
Aspect 40: The method of any of Aspects 33-39, further comprising: transmitting, via a second cell, configuration information for one or more resources associated with requests for system information; and transmitting, via the first cell, an indication of updated configuration information for the one or more resources.
Aspect 41: The method of Aspect 40, wherein the indication of the updated configuration information is included in the communication or in another system information communication.
Aspect 42: The method of any of Aspects 40-41, wherein the indication of the updated configuration information indicates that the updated configuration information is available via the second cell, the method further comprising: transmitting, via the second cell and in association with receiving the indication of the updated configuration information, the updated configuration information.
Aspect 43: The method of any of Aspects 33-42, wherein the UE is in a connected mode with a connection to the first cell prior to receiving the communication, the method further comprising: transmitting, via the first cell and while the UE is in the connected mode, assistance information for accessing the first cell when the first cell is operating in the NES mode.
Aspect 44: The method of Aspect 43, wherein the assistance information includes at least one of: configuration information for one or more resources associated with requests for system information, the one or more conditions, or the RMSI.
Aspect 45: The method of any of Aspects 33-44, further comprising: receiving, via a second cell, a request for system information for the first cell, wherein receiving the request is in association with the one or more conditions being met.
Aspect 46: The method of any of Aspects 33-45, further comprising: transmitting, via a second cell and prior to transmitting the communication, partial system information for the first cell.
Aspect 47: The method of Aspect 46, wherein the partial system information includes at least one of: a public land mobile network identifier, or cell access information.
Aspect 48: The method of any of Aspects 33-47, further comprising: receiving, via a second cell, a request for system information for the first cell, the request including an indication of spatial domain information associated with the UE and the first cell.
Aspect 49: The method of Aspect 48, further comprising: transmitting, via the first cell, a synchronization signal block (SSB) prior to receiving the communication, wherein the spatial domain information includes an index of the SSB.
Aspect 50: The method of any of Aspects 48-49, further comprising: transmitting an acknowledgement communication associated with the request indicating whether the first cell is to transmit the communication.
Aspect 51: The method of any of Aspects 33-50, further comprising: transmitting, via the first cell, a broadcast channel communication indicating assistance information for obtaining the RMSI via a second cell.
Aspect 52: The method of Aspect 51, wherein the assistance information includes at least one of: frequency resources via which the second cell is to transmit the communication, a cell identifier of the second cell, an area identifier of the second cell, or information for receiving the communication via the second cell.
Aspect 53: The method of any of Aspects 33-52, wherein the network node is a first network node, wherein the first network node is associated with the first cell, and wherein receiving the request for the system information comprises: receiving, from a second network node, the request for system information.
Aspect 54: The method of Aspect 53, wherein the request for system information includes at least one of: spatial domain information for the communication, a timing of the communication, an indication to activate transmission of the RMSI, or an indication of a cause of the request.
Aspect 55: The method of any of Aspects 53-54, further comprising: transmitting, to the second network node, an indication of whether the first network node is to transmit the communication.
Aspect 56: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-55.
Aspect 57: An apparatus for wireless communication at a device, the apparatus comprising one or more memories and one or more processors coupled to the one or more memories, the one or more processors configured to cause the device to perform the method of one or more of Aspects 1-55.
Aspect 58: An apparatus for wireless communication, the apparatus comprising at least one means for performing the method of one or more of Aspects 1-55.
Aspect 59: A non-transitory computer-readable medium storing code for wireless communication, the code comprising instructions executable by one or more processors to perform the method of one or more of Aspects 1-55.
Aspect 60: A non-transitory computer-readable medium storing a set of instructions for wireless communication, the set of instructions comprising one or more instructions that, when executed by one or more processors of a device, cause the device to perform the method of one or more of Aspects 1-55.
Aspect 61: A device for wireless communication, the device comprising a processing system that includes one or more processors and one or more memories coupled with the one or more processors, the processing system configured to cause the device to perform the method of one or more of Aspects 1-55.
Aspect 62: An apparatus for wireless communication at a device, the apparatus comprising one or more memories and one or more processors coupled to the one or more memories, the one or more processors individually or collectively configured to cause the device to perform the method of one or more of Aspects 1-55.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based on or otherwise in association with” unless explicitly stated otherwise. Also, as used herein, the term “or” is intended to be inclusive when used in a series and may be used interchangeably with “and/or,” unless explicitly stated otherwise (for example, if used in combination with “either” or “only one of”). It should be understood that “one or more” is equivalent to “at least one.”

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set.

What is claimed is:

1. A user equipment (UE) for wireless communication, comprising:
one or more memories; and
one or more processors, coupled to the one or more memories, configured to cause the UE to:
receive a communication including remaining minimum system information (RMSI) for a first cell that is operating in a network energy saving (NES) mode; and
perform an operation associated with a selection of the first cell, the selection of the first cell being in accordance with one or more conditions being met.

2. The UE of claim 1, wherein the operation includes selecting the first cell for establishing a connection, wherein the one or more processors, to cause the UE to receive the communication, are configured to cause the UE to:
receive, from a second cell, the communication,
wherein the one or more conditions being met includes the UE being associated with an authorized subscription for accessing the first cell.

3. The UE of claim 1, wherein the operation includes selecting the first cell for establishing a connection, wherein the one or more processors, to cause the UE to receive the communication, are configured to cause the UE to:
receive, from a second cell, the communication; and
receive, from the second cell, an indication that the UE is authorized to access the first cell,
wherein the one or more conditions being met includes the UE receiving the indication that the UE is authorized to access the first cell.

4. The UE of claim 1, wherein the one or more processors are further configured to cause the UE to:
receive, from a second cell, a paging communication,
wherein the one or more conditions being met includes the UE receiving the paging communication.

5. The UE of claim 1, wherein the operation is associated with the UE having uplink traffic to transmit, and wherein the one or more conditions are associated with the uplink traffic having at least one of:
an allowable traffic type,
an allowable quality of service class, or
an allowable purpose.

6. The UE of claim 1, wherein the one or more processors are further configured to cause the UE to:
transmit, to the first cell, a request for the communication, the transmission of the request being associated with the one or more conditions being met,
wherein the communication is in response to transmitting the request.

7. The UE of claim 1, wherein the operation includes camping on the first cell and wherein the one or more processors, to cause the UE to receive the communication, are configured to cause the UE to:
receive, from the first cell, one or more system information communications including the RMSI, the one or more system information communications being received during one or more periods prior to a paging occasion for an idle discontinuous reception cycle that is configured for the UE.

8. The UE of claim 7, wherein the one or more processors are further configured to cause the UE to:
receive, from the first cell or second cell, updated configuration information for the one or more system information communications.

9. The UE of claim 1, wherein the one or more processors are further configured to cause the UE to:
receive, from a second cell, configuration information for one or more resources associated with requests for system information;
transmit, to the second cell, a request for system information using at least one of the one or more resources, wherein the communication is in response to transmitting the request; and
receive, from the first cell, an indication of updated configuration information for the one or more resources.

10. The UE of claim 1, wherein the UE is operating in a connected mode with a connection to the first cell prior to receiving the communication, wherein the one or more processors are further configured to cause the UE to:
receive, from the first cell and while operating in the connected mode, assistance information for accessing the first cell when the first cell is operating in the NES mode.

11. The UE of claim 1, wherein the one or more processors are further configured to cause the UE to:
receive, from a second cell and prior to receiving the communication, partial system information for the first cell.

12. The UE of claim 1, wherein the one or more processors are further configured to cause the UE to:
transmit, to a second cell, a request for system information for the first cell, the request including an indication of spatial domain information associated with the UE and the first cell, and wherein receiving the communication comprises:
receive, from the first cell, the communication in response to transmitting the request.

13. The UE of claim 1, wherein the one or more processors are further configured to cause the UE to:
receive, from the first cell, a broadcast channel communication indicating assistance information for obtaining the RMSI via a second cell.

14. A network node for wireless communication, comprising:
one or more memories; and
one or more processors, coupled to the one or more memories, configured to cause the network node to:
receive, for a user equipment (UE), a request for system information for a first cell that is operating in a network energy saving (NES) mode; and
transmit a communication including remaining minimum system information (RMSI) for the first cell in accordance with one or more conditions being met.

15. The network node of claim 14, wherein the network node is a first network node, wherein the first network node is associated with the first cell, and wherein the one or more processors, to cause the network node to receive the request for the system information, are configured to cause the network node to:
receive, from a second network node, the request for system information.

16. The network node of claim 15, wherein the request for system information includes at least one of:
spatial domain information for the communication,
a timing of the communication,
an indication to activate transmission of the RMSI, or
an indication of a cause of the request.

17. The network node of claim 15, wherein the one or more processors are further configured to cause the network node to:
transmit, to the second network node, an indication of whether the first network node is to transmit the communication.

18. A method of wireless communication performed by a user equipment (UE), comprising:
receiving a communication including remaining minimum system information (RMSI) for a first cell that is operating in a network energy saving (NES) mode; and
performing an operation associated with a selection of the first cell, the selection of the first cell being in accordance with one or more conditions being met.

19. The method of claim 18, wherein the operation includes selecting the first cell for establishing a connection, wherein receiving the communication comprises:
receiving, from a second cell, the communication,
wherein the one or more conditions being met includes the UE being associated with an authorized subscription for accessing the first cell.

20. The method of claim 18, wherein the operation includes selecting the first cell for establishing a connection, wherein receiving the communication comprises:
receiving, from a second cell, the communication; and
receiving, from the second cell, an indication that the UE is authorized to access the first cell,
wherein the one or more conditions being met includes the UE receiving the indication that the UE is authorized to access the first cell.
